(19) United States
(12) Patent Application Publication
(10) Pub. No.: US 2007/0056835 A1
(43) Pub. Date: Mar. 15, 2007

(54) System and method for actuating one or more sliders

(75) Inventors: Joseph Michael Manahan, Manlius, NY (US); Clifford Randy Helmer, Fulton, NY (US)

Correspondence Address: HAYNES AND BOONE, LLP, 901 MAIN STREET, SUITE 3100, DALLAS, TX, 75202, US

(73) Assignee: Cooper Industries, Inc., Houston, TX (US)

(21) Appl. No.: 11/224,789

(22) Filed: Sep. 13, 2005

(51) Int. Cl. H01H 9/22; H01H 11/00

(52) U.S. Cl. 200/50.02; 29/622

(57) ABSTRACT

A system and method according to which one or more sliders are actuated in order to, for example, operate one or more switches such as, for example, one or more circuit breaker switches.

### BACKGROUND

The present disclosure relates in general to a system and method for actuating one or more sliders and in particular to a system and method for actuating one or more sliders to operate one or more switches such as, for example, one or more circuit breaker switches. The one or more sliders may be positioned in an enclosure such as, for example, a panelboard.

### SUMMARY

According to one aspect of the present disclosure, a system is provided that includes a slider positioned in one of at least two positions; a device adapted to approach and engage the slider; and means for automatically adjusting the device to a position corresponding to the one of the at least two positions of the slider during the device's approach and engagement with the slider so that the slider remains in the one of the at least two positions, wherein the device is permitted to actuate the slider when the device is in the position corresponding to the one of the at least two positions of the slider.

According to another aspect of the present disclosure, a system is provided that includes a slider positioned in one of at least two positions and comprising at least one protrusion; an enclosure in which the slider is disposed; a pin adapted to approach and engage the slider; and means for automatically adjusting the pin to a position corresponding to the one of the at least two positions of the slider during the pin's approach and engagement with the slider so that the slider remains in the one of the at least two positions, comprising an angularly-extending surface defined by the protrusion and adapted to engage the pin during the pin's approach and engagement with the slider; and means for permitting the pin to rotate in response to the pin's approach and the engagement of the pin with the angularly-extending surface, comprising a shaft connected to the pin and comprising a longitudinal axis; a bearing coupled to the shaft, wherein the shaft is adapted to rotate in a first direction about its longitudinal axis in response to the pin's approach and the engagement of the pin with the angularly-extending surface; and a cover connected to the enclosure and to which the bearing is coupled wherein the pin is adapted to approach and engage the slider in response to the closing of the cover; wherein, when the cover is closed and the pin is engaged with the slider and in the position corresponding to the one of the at least two positions of the slider, the pin is adapted to rotate and actuate the slider in response to rotation of the shaft in a second direction about its longitudinal axis; and wherein, in response to the actuation of the slider, the slider is positioned in another of the at least two positions and a circuit breaker switch is operated.

According to another aspect of the present disclosure, a method is provided that includes moving a device so that the device approaches and engages a slider positioned in one of at least two positions; and automatically adjusting the device to a position corresponding to the one of the at least two positions of the slider during the device's approach and engagement with the slider so that the slider remains in the one of the at least two positions; wherein the device is permitted to actuate the slider when the device is in the position corresponding to the one of the at least two positions of the slider.

According to another aspect of the present disclosure, a method is provided that includes engaging a slider with a switch so that the slider is positioned in one of at least two positions; moving a device so that the device approaches and engages the slider positioned in the one of the at least two positions, comprising moving a cover of an enclosure in which the slider is housed, the device being coupled to the cover and comprising a pin; automatically adjusting the device to a position corresponding to the one of the at least two positions of the slider during the device's approach and engagement with the slider so that the slider remains in the one of the at least two positions, comprising engaging the pin with an angularly-extending surface of the slider, wherein the pin rotates to a position corresponding to the one of the at least two positions of the slider in response to the device's approach and the engagement of the pin with the angularly-extending surface, and wherein the device is permitted to actuate the slider when the device is in the position corresponding to the one of the at least two positions of the slider; and actuating the slider so that the slider is positioned in another of the at least two positions after automatically adjusting the device to a position corresponding to the one of the at least two positions of the slider during the device's approach and engagement with the slider, comprising rotating the pin so that the pin cammingly engages the slider; wherein a circuit breaker switch is operated in response to actuating the slider so that the slider is positioned in the another of the at least two positions.

According to another aspect of the present disclosure, a system is provided that includes first and second circuit breakers positioned in a side-by-side symmetric arrangement, each of the first and second circuit breakers comprising two or more operational modes and at least one of the first and second circuit breakers comprising a button; first and second sliders engaging the first and second circuit breakers, respectively, wherein the first and second sliders are aligned with each other; and means for permitting access to the button during each of the two or more operational modes of the at least one of the first and second circuit breakers.

According to another aspect of the present disclosure, a system is provided that includes first and second circuit breakers positioned in a side-by-side symmetric arrangement, each of the first and second circuit breakers comprising two or more operational modes and at least one of the first and second circuit breakers comprising a button; first and second sliders engaging the first and second circuit breakers, respectively, wherein the first and second sliders are aligned with each other; and means for permitting access to the button during each of the two or more operational modes of the at least one of the first and second circuit breakers, comprising a slot in at least one of the first and second sliders, the at least one of the first and second sliders engaging the at least one of the first and second circuit breakers; means for overlapping the first and second sliders so that the first and second sliders do not interfere with one another, comprising a first end portion of the first slider, the first end portion defining a first width that is less than a first maximum width defined by the first slider; and a second end portion of the second slider, the second end portion defining a second width that is less than a second maximum width defined by the second slider; wherein the first and second end portions of the first and second sliders, respectively, overlap during each of the two or more operational modes of the at least one of the first and second circuit breakers; means for guiding the first and second end portions during relative overlapping movement between the first and second end portions; means at least partially extending in the slot for activating the button, wherein the activating means at least partially extends in the slot during each of the two or more operational modes of the at least one of the first and second circuit breakers; and means for actuating each of the first and second sliders, comprising a first device adapted to approach and engage the first slider; and a second device adapted to approach and engage the second slider; wherein the first circuit breaker is in one of the two or more operational modes of the first circuit breaker during the first device's approach; wherein the second circuit breaker is in one of the two or more operational modes of the second circuit breaker during the second device's approach; wherein the system further comprises means for automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and means for automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker; and wherein the button is able to be viewed through the slot during each of the two or more operational modes of the at least one of the first and second circuit breakers.

According to another aspect of the present disclosure, a method is provided that includes positioning first and second circuit breakers in a side-by-side symmetric arrangement, each of the first and second circuit breakers comprising two or more operational modes and at least one of the first and second circuit breakers comprising a button; engaging the first and second circuit breakers with first and second sliders, respectively, wherein the first and second sliders are aligned with each other after engaging the first and second circuit breakers, respectively; and permitting access to the button during each of the two or more operational modes of the at least one of the first and second circuit breakers.

According to another aspect of the present disclosure, a method is provided that includes positioning first and second circuit breakers in a side-by-side symmetric arrangement, each of the first and second circuit breakers comprising two or more operational modes and at least one of the first and second circuit breakers comprising a button; engaging the first and second circuit breakers with first and second sliders, respectively, wherein the first and second sliders are aligned with each other; and permitting access to the button during each of the two or more operational modes of the at least one of the first and second circuit breakers, comprising providing a slot in at least one of the first and second sliders, the at least one of the first and second sliders engaging the at least one of the first and second circuit breakers; overlapping the first and second sliders so that the first and second sliders do not interfere with one another, comprising overlapping a first end portion of the first slider with a second end portion of the second slider during each of the two or more operational modes of the at least one of the first and second circuit breakers; wherein the first end portion defines a first width that is less than a first maximum width defined by the first slider; and wherein the second end portion defines a second width that is less than a second maximum width defined by the second slider; guiding the first and second end portions during relative overlapping movement between the first and second end portions; activating the button by at least partially extending a device in the slot; and actuating each of the first and second sliders, comprising moving a first device so that the first device approaches and engages the first slider; and moving a second device so that the second device approaches and engages the second slider; wherein the first circuit breaker is in one of the two or more operational modes of the first circuit breaker during the first device's approach; wherein the second circuit breaker is in one of the two or more operational modes of the second circuit breaker during the second device's approach; wherein the method further comprises automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker; and wherein the button is able to be viewed through the slot during each of the two or more operational modes of the at least one of the first and second circuit breakers.

According to another aspect of the present disclosure, an apparatus is provided that includes first and second circuit breakers wherein the second circuit breaker is positioned directly beneath the first circuit breaker; first and second sliders engaged with the first and second circuit breakers, respectively; and first and second operators for actuating the first and second sliders, respectively, wherein the second operator is aligned with and positioned directly beneath the first operator so that the relative positions of the first and second operators correspond to the relative positions of the first and second circuit breakers.

According to another aspect of the present disclosure, an apparatus is provided that includes first and second circuit breakers wherein the second circuit breaker is positioned directly beneath the first circuit breaker; first and second sliders engaged with the first and second circuit breakers, respectively; and first and second operators for actuating the first and second sliders, respectively, wherein the second operator is aligned with and positioned directly beneath the first operator so that the relative positions of the first and second operators correspond to the relative positions of the first and second circuit breakers; wherein each of the first and second operators comprises a handle, each handle comprising an angularly-extending portion so that the handle of the second operator is in a nesting arrangement with the handle of the first operator; wherein each handle is adapted to rotate to actuate the respective first or second slider and wherein the nesting arrangement permits the second handle to rotate, relative to the first handle, over at least a predetermined range of rotation; wherein each of the first and second circuit breakers comprises a switch engaged with the respective first or second slider so that the switch is operated in response to the actuation of the respective first or second slider; wherein each of the first and second operators comprises a shaft comprising a longitudinal center axis and wherein the longitudinal center axis of the shaft of the second operator extends between the first and second circuit breakers; wherein a spacing is defined between the centerline of the switch of the second circuit breaker and the longitudinal axis of the shaft of the second operator; wherein each of the first and second circuit breakers defines a width; and wherein the spacing is substantially equal to about half of the width of the second circuit breaker to accommodate a compact arrangement between the first and second circuit breakers.

According to another aspect of the present disclosure, an apparatus for approaching and actuating a slider engaged with a device is provided that includes a shaft comprising a longitudinal center axis about which the shaft is adapted to rotate in place; and a pin connected to the shaft, wherein the pin is adapted to rotate and engage the slider in response to the rotation of the shaft; wherein the slider translates in response to the engagement between the pin and the slider.

According to another aspect of the present disclosure, an apparatus for approaching and actuating a slider engaged with a circuit breaker is provided that includes a shaft comprising an external threaded connection and a longitudinal center axis about which the shaft is adapted to rotate in place; and a pin connected to the shaft and adapted to rotate in response to the rotation of the shaft, the pin comprising a base defining a diameter of about 0.352 inches, a cam lobe extending from the base and defining a radius of about 0.750 inches, wherein the cam lobe cammingly engages the slider in response to the rotation of the shaft and the slider translates in response to the camming engagement between the cam lobe and the slider, and a planar surface adapted to be positioned proximate the slider during the camming engagement between the cam lobe and the slider; a handle connected to the shaft and aligned with the pin, the handle comprising an angularly-extending portion that is adapted to be placed in a nesting arrangement with at least one other handle, wherein the nesting arrangement between the handle and the at least one other handle permits the handle to rotate over at least a predetermined range of rotation; and a bearing through which the shaft extends, the bearing comprising an internal threaded connection threadably engaged with the external threaded connection of the shaft; wherein a switch of the circuit breaker is operated in response to the translation of the slider, the switch comprising a centerline that extends in the direction of translation of the slider, wherein a predetermined distance of about 0.5 inches is defined between the longitudinal center axis of the shaft and the centerline of the switch; and wherein the predetermined range of rotation comprises a range of rotation in a first direction to place the switch in at least one position, and a range of rotation in a second direction opposing the first direction to place the switch in at least one other position.

According to another aspect of the present disclosure, an apparatus for approaching and actuating a slider engaged with a circuit breaker is provided that includes a shaft comprising an external threaded connection and a longitudinal center axis about which the shaft is adapted to rotate in place; and a pin connected to the shaft and adapted to rotate in response to the rotation of the shaft, the pin comprising a generally cylindrical first portion extending from the shaft in a first direction, the first portion defining a first diameter of about 0.25 inches; and a generally cylindrical second portion extending from the first portion in a second direction, the second portion defining a second diameter that is substantially equal to the first diameter; wherein the second portion cammingly engages the slider in response to the rotation of the shaft and the slider translates in response to the camming engagement between the second portion and the slider; and wherein an angle of about 150 degrees is defined between the first and second directions; a handle connected to the shaft, the handle comprising an angularly-extending portion that is adapted to be placed in a nesting arrangement with at least one other handle, wherein the nesting arrangement between the handle and the at least one other handle permits the handle to rotate over at least a predetermined range of rotation; a bearing through which the shaft extends, the bearing comprising an internal threaded connection threadably engaged with the external threaded connection of the shaft; wherein a switch of the circuit breaker is operated in response to the translation of the slider, the switch comprising a centerline that extends in the direction of translation of the slider, wherein a predetermined distance of about 1.5 inches is defined between the longitudinal center axis of the shaft and the centerline of the switch; and wherein the predetermined range of rotation comprises a range of rotation in a first direction to place the switch in at least one position, and a range of rotation in a second direction opposing the first direction to place the switch in at least one other position.

### BRIEF DESCRIPTION OF THE DRAWINGS

FIG. 1 is a perspective view of a panelboard including a cover that is closed and a plurality of operators according to an embodiment.

FIG. 2 is a perspective view of the panelboard of FIG. 1 but depicting the cover open and components according to an embodiment positioned in the panelboard.

FIG. 3 is an enlarged perspective view of a portion of the components of FIG. 2.

FIG. 4 is a view similar to that of FIG. 3 but depicting an enlarged partial perspective/partial sectional portion thereof.

FIG. 5 is a perspective view of a slider according to an embodiment.

FIG. 6 is another perspective view of the slider of FIG. 5.

FIG. 7 is an elevational view of the slider of FIG. 5.

FIG. 8 is a plan view of the slider of FIG. 5.

FIG. 9 is an exploded view of one of the operators of FIG. 1.

FIG. 10 is an elevational view of a handle of the operator of FIG. 9.

FIG. 11 is an unexploded view of the operator of FIG. 9 and the slider of FIGS. 5-8.

FIG. 12 is an elevational view of a portion of the operator of FIG. 9.

FIG. 13A is an elevational view of a portion of the components of FIG. 2 in an operational position.

FIG. 13B is a plan view of the portion of the components depicted in FIG. 13A.

FIG. 14A is a view similar to that of FIG. 13A but depicting another operational position for some of the components.

FIG. 14B is a plan view of the portion of the components depicted in FIG. 14A.

FIG. 15 is a perspective view depicting an operational engagement of the operator of FIG. 9 and the slider of FIGS. 5-8.

FIG. 16 is an exploded view of an operator according to another embodiment.

FIG. 17 is an elevational view of a handle of the operator of FIG. 16.

FIG. 18 is a top plan view of a pin of the operator of FIG. 16.

FIG. 19 is a perspective view of the operator of FIG. 16 and a slider that is similar to the slider of FIGS. 5-8.

FIG. 20A is an elevational view of the operator of FIG. 16 in an operational position.

FIG. 20B is a view similar to that of FIG. 20A but depicting another operational position.

### DETAILED DESCRIPTION OF THE ILLUSTRATIVE EMBODIMENTS

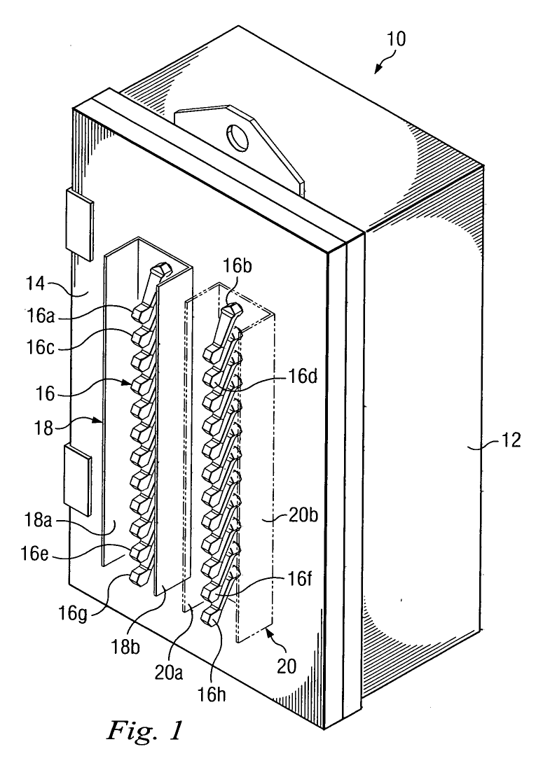

In an exemplary embodiment, as illustrated in FIG. 1, an enclosure such as, for example, a panelboard is generally referred to by the reference numeral 10 and includes an enclosure body 12 and a cover 14 hingedly connected thereto. In an exemplary embodiment, the panelboard 10 may be explosion proof and/or may be used in a wide variety of different applications and/or environments such as, for example, branch power distribution and/or circuit protection in areas made hazardous by, for example, the presence of flammable gases, vapors, and/or combustible dusts, and/or the presence of dampness and/or corrosion. In an exemplary embodiment, the cover 14 may be closed and secured to the enclosure body 12 by, for example, a plurality of captive hex-head bolts.

A plurality of devices such as, for example, a plurality of operators 16 extend through and are coupled to the cover 14, and include operators 16a, 16b, 16c, 16d, 16e, 16f, 16g and 16h. The operators 16a, 16c, 16e and 16g are all aligned with each other, and the operators 16b, 16d, 16f and 16h are all aligned with each other. The operators 16c and 16d are positioned directly beneath the operators 16a and 16b, respectively, and the operators 16g and 16h are positioned directly beneath the operators 16e and 16f, respectively. The operators 16 will be described in further detail below.

A lockout plate 18 is connected to the cover 14 and includes walls 18a and 18b that extend away from the cover and partially enclose a portion of the plurality of operators 16, including the operators 16a, 16c, 16e and 16g. Similarly, a lockout plate 20 is connected to the cover 14 and includes walls 20a and 20b that extend away from the cover and partially enclose another portion of the plurality of operators 16, including the operators 16b, 16d, 16f and 16h.

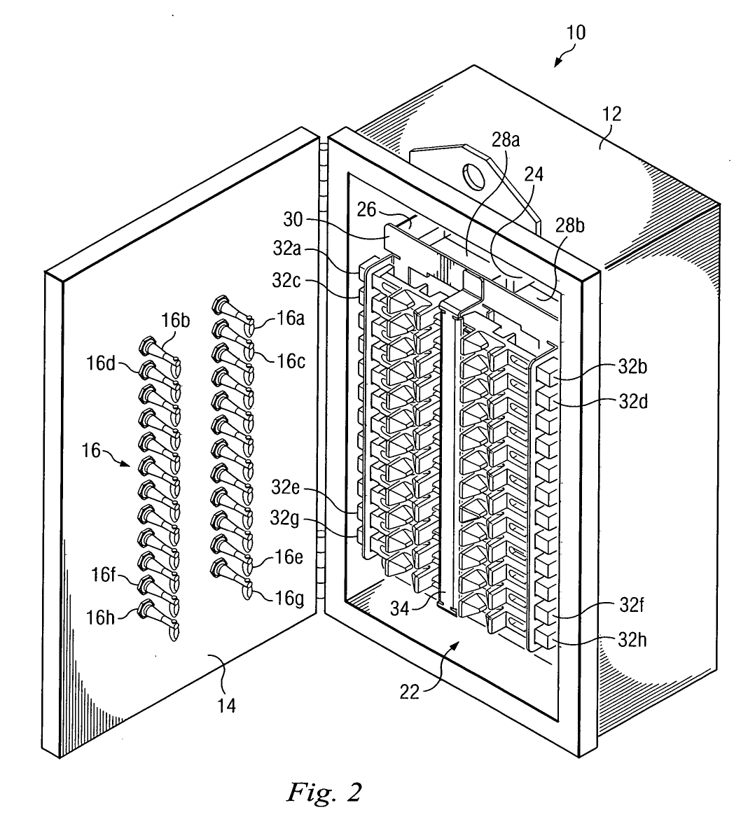

In an exemplary embodiment, as illustrated in FIG. 2, the enclosure body 12 defines a chamber 22 in which a mounting plate 24 is positioned. A chassis 26 is coupled to the mounting plate 22 and a plurality of circuit breakers 28 are mounted to the chassis, including circuit breakers 28a and 28b. In an exemplary embodiment, the plurality of circuit breakers 28 may be divided into at least two columns of circuit breakers 28 so that the columns define a plurality of pairs of circuit breakers 28 positioned in an operational side-by-side symmetric arrangement, including symmetric circuit breakers 28a and 28b.

A plate member 30 is connected to the chassis 26 and a plurality of sliders 32 are slidably engaged with the plate member, including pairs of vertically-aligned sliders 32a and 32b, 32c and 32d, 32e and 32f, and 32g and 32h. A strip 34 is connected to the plate member 30, the strip and the plate member retaining the sliders 32 in a manner to be described in further detail below. In an exemplary embodiment, the quantity of circuit breakers 28 may be equal to the quantity of sliders 32 which, in turn, may be equal to the quantity of operators 16.

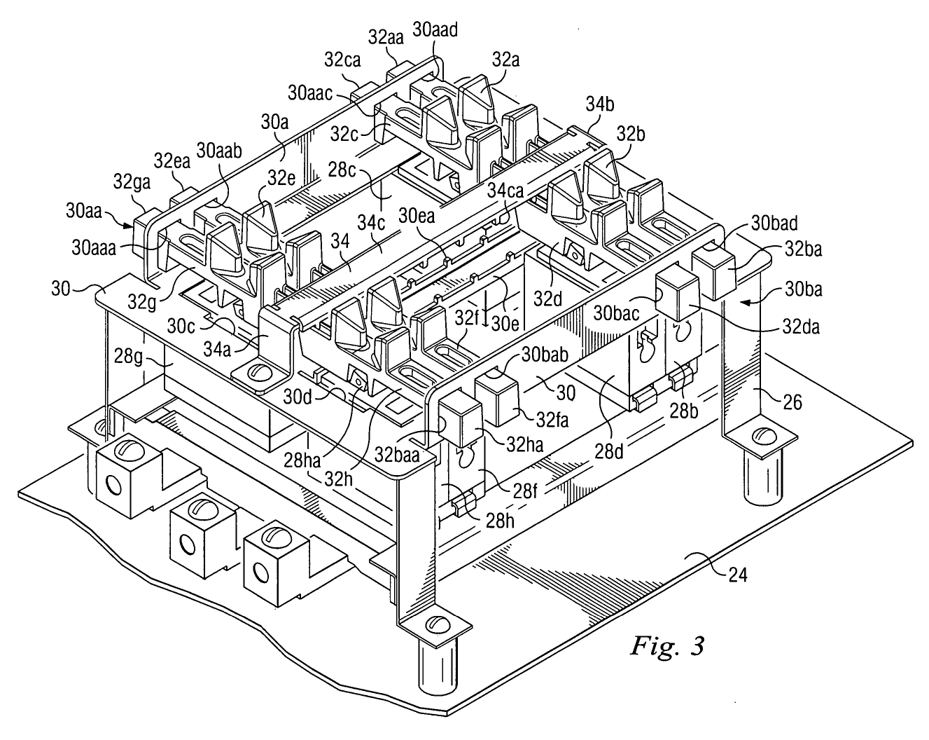

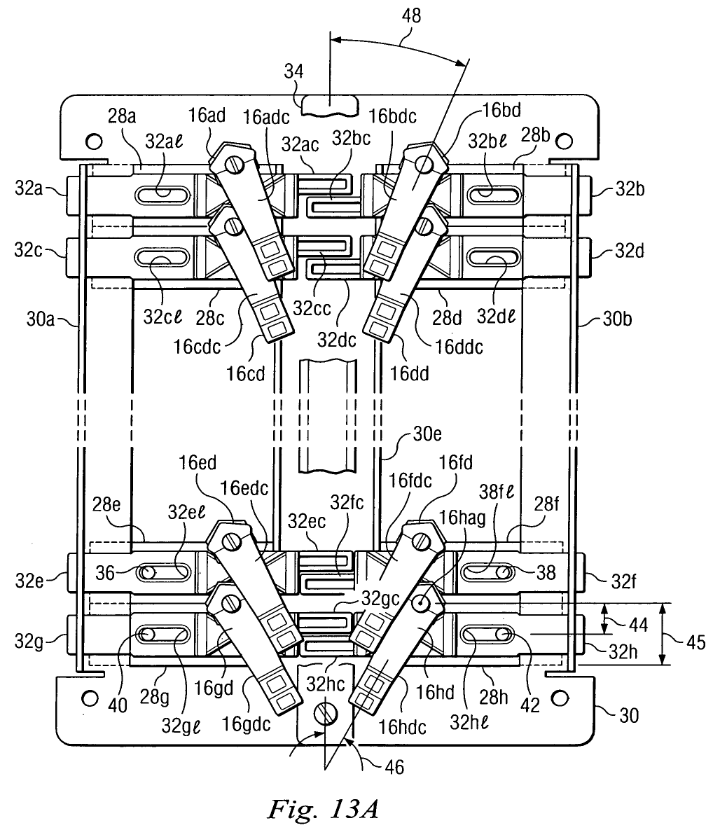

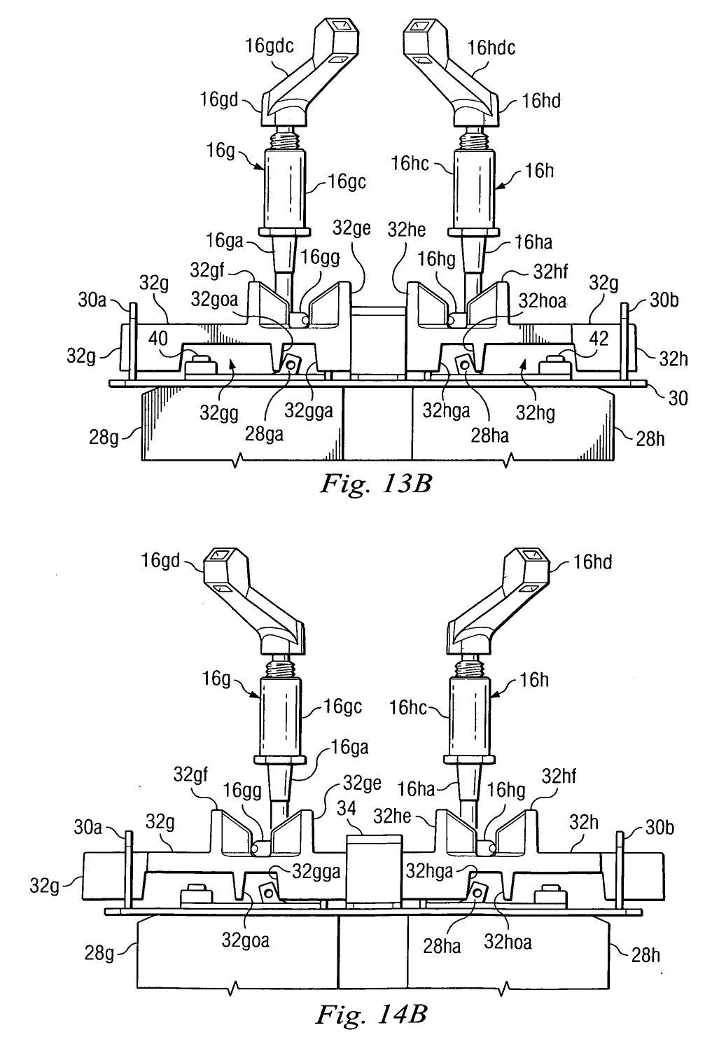

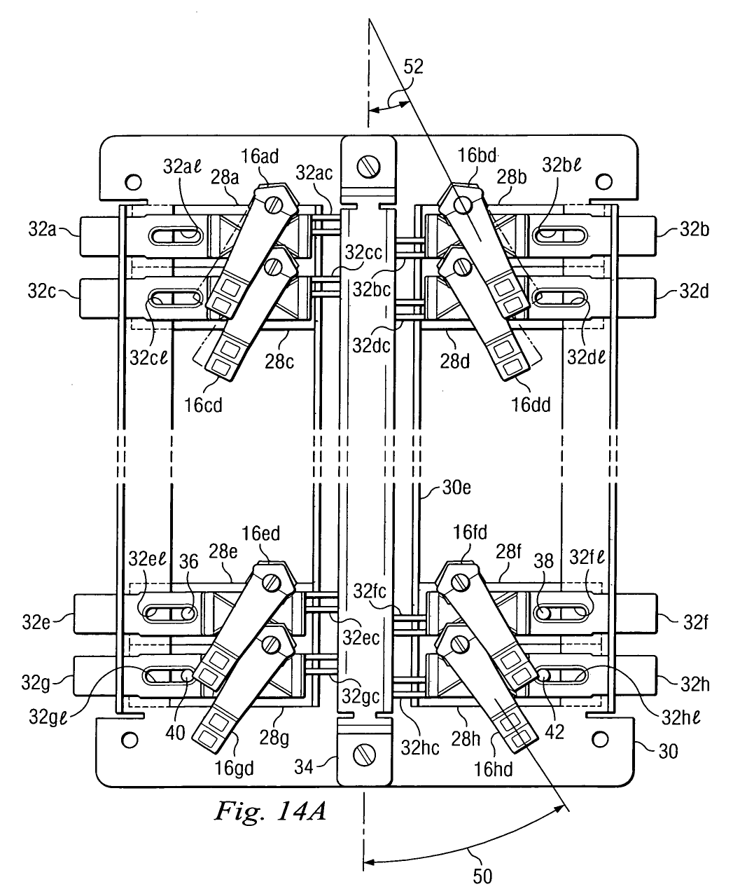

In an exemplary embodiment, as illustrated in FIG. 3, the plurality of circuit breakers 28 further includes circuit breakers 28c, 28d, 28f, 28g and 28h, and a circuit breaker 28e that is behind the slider 32e and hidden from view (see FIGS. 13A and 14A). In an exemplary embodiment, in addition to the pair of circuit breakers 28a and 28b, the pairs of circuit breakers 28c and 28d, 28e and 28f, and 28g and 28h, are each positioned in an operational side-by-side symmetric arrangement. As shown in FIG. 3, with reference to FIG. 2, the circuit breakers 28c and 28d are positioned directly beneath the circuit breakers 28a and 28b, respectively, and the circuit breakers 28g and 28h are positioned directly beneath the circuit breakers 28e and 28f, respectively. The relative positions of the operators 16a, 16c, 16e and 16g correspond to the relative positions of the circuit breakers 28a, 28c, 28e and 28g, respectively, and the relative positions of the operators 16b, 16d, 16f and 16h correspond to the relative positions of the circuit breakers 28b, 28d, 28f and 28h, respectively. The remainder of the circuit breakers 28 and/or the sliders 32 that are depicted in FIG. 2 are removed from FIG. 3 for the purpose of clarity.

The plate member 30 includes a pair of walls 30a and 30b, and a plurality of openings 30baa is formed in the wall 30a, including openings 30aaa, 30aab, 30aac and 30aad. End portions 32aa, 32ca, 32ea and 32ga of the sliders 32a, 32c, 32e and 32g, respectively, extend through the openings 30aad, 30aac, 30aab and 30aaa, respectively. Similarly, a plurality of openings 30ba is formed in the wall 30b, including openings 30baa, 30bab, 30bac and 30bad. End portions 32ba, 32da, 32fa and 32ha of the sliders 32b, 32d, 32f and 32h, respectively, extend through the openings 30bad, 30bac, 30bab and 30baa, respectively. A through-opening 30c is formed in the plate member 30, and the sliders 32a, 32c, 32e and 32g extend across the through-opening. Similarly, a through-opening 30d is formed in the plate member 30, and the sliders 32b, 32d, 32f and 32h extend across the through-opening. A U-shaped center bar 30e separates the through-openings 30c and 30d, and includes a plurality of projections 30ea.

The strip 34 includes a pair of opposing and symmetric L-shaped tabs 34a and 34b, via which the strip is connected to the plate member 30. A U-shaped middle portion 34c extends between the tabs and includes a plurality of projections 34ca that extend towards the center bar 30e of the plate member 30.

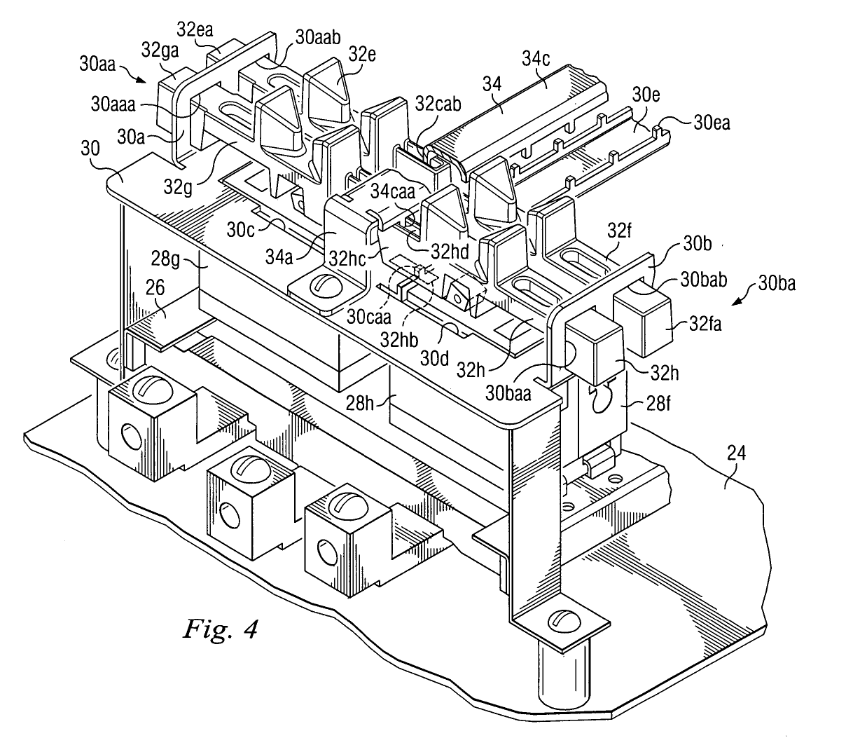

In an exemplary embodiment, as illustrated in FIG. 4, a projection 30eaa in the plurality of projections 30ea engages the slider 32h, extending into a channel 32hb formed in an end portion 32hc of the slider 32h that extends between the plate member 30 and the strip 34. Although not shown in FIG. 4, other projections in the plurality of projections 30ea engage the sliders 32a, 32b, 32c, 32d, 32e, 32f and 32g, respectively, in a manner substantially similar to the manner in which the projection 30eaa engages the slider 32h.

A projection 34caa in the plurality of projections 34ca engages the slider 32h, extending into a channel 32hd formed in the end portion 32hc of the slider 32h. A projection 34cab engages the slider 32e in a manner substantially similar to the manner in which the projection 34caa engages the slider 32h. Although not shown in FIG. 4, other projections in the plurality of projections 34ca engage the sliders 32a, 32b, 32c, 32d, 32f and 32g, respectively, in a manner substantially similar to the manner in which the projection 34caa engages the slider 32h.

In an exemplary embodiment, the plate member 30 and the strip 34 retain the sliders 32a, 32c, 32e and 32g via the extension of the end portions 32aa, 32ca, 32ea and 32ga of the sliders 32a, 32c, 32e and 32g, respectively, through the openings 30aad, 30aac, 30aab and 30aaa, respectively, and via the engagement of the projections in the plurality of projections 34ca with the respective sliders 32a, 32c, 32e and 32g, while permitting the sliders 32a, 32c, 32e and 32g to slide, relative to the plate member 30 and the strip 34, towards or away from the center bar 30e. Similarly, the plate member 30 and the strip 34 retain the sliders 32b, 32d, 32f and 32h via the extension of the end portions 32ba, 32da, 32fa and 32ha of the sliders 32b, 32d, 32f and 32h, respectively, through the openings 30bad, 30bac, 30bab and 30baa, respectively, and via the engagement of the projections in the plurality of projections 34ca with the respective sliders 32b, 32d, 32f and 32h, while permitting the sliders 32b, 32d, 32f and 32h to slide, relative to the plate member 30 and the strip 34, towards or away from the center bar 30e.

At least a portion of the circuit breaker 28h extends through the through-opening 30d to permit the slider 32h to engage and operate a switch 28ha of the circuit breaker 28h to operate the circuit breaker in a manner to be described in detail below. In an exemplary embodiment, at least portions of the circuit breakers 28b, 28d and 28f also extend through the through-opening 30d in a manner similar to the manner in which the at least a portion of the circuit breaker 28h extends through the through-opening. In an exemplary embodiment, at least portions of the circuit breakers 28a, 28c, 28e and 28g extend through the through-opening 30c in a manner similar to the manner in which the at least a portion of the circuit breaker 28h extends through the through-opening 30d.

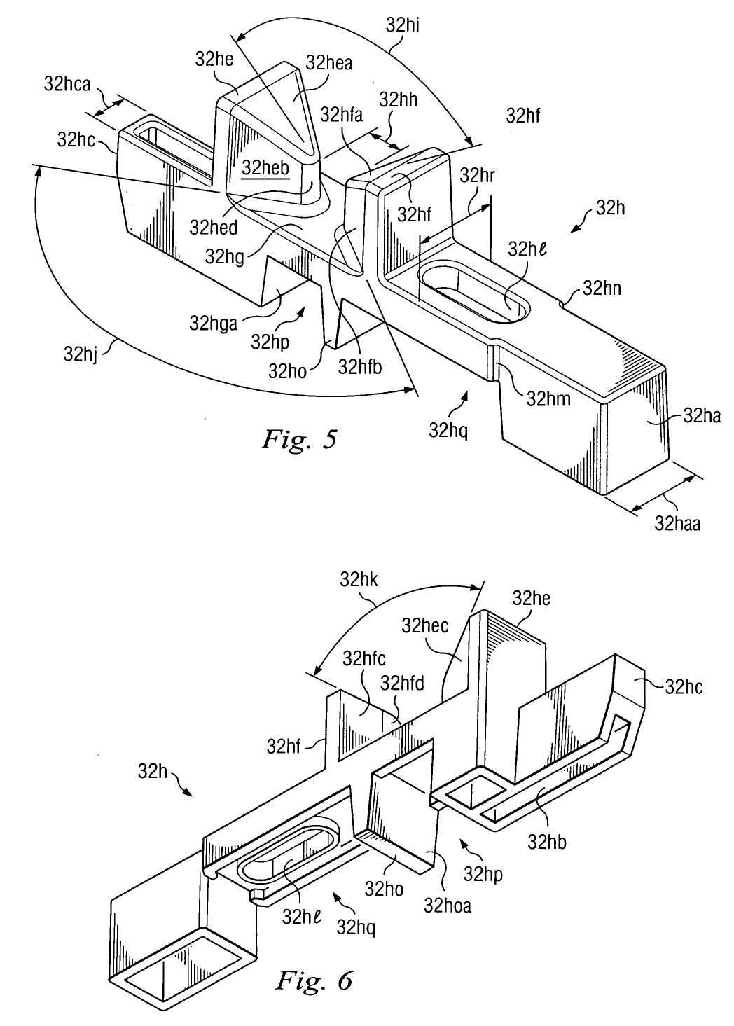

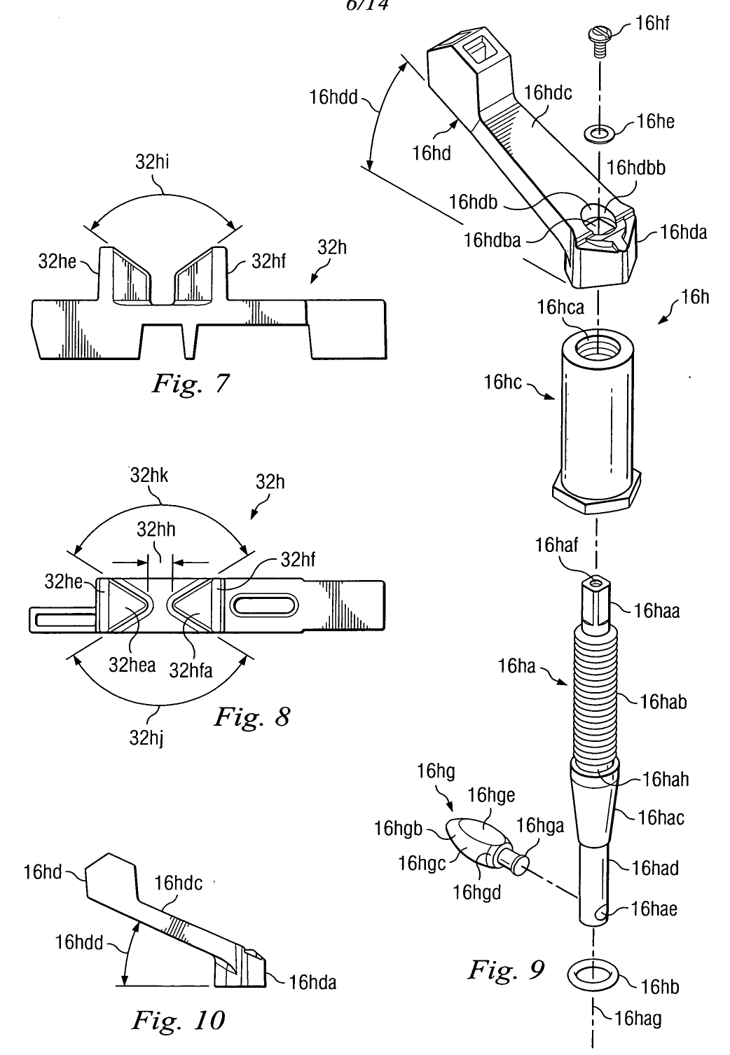

In an exemplary embodiment, as illustrated in FIGS. 5, 6, 7 and 8, protrusions 32he and 32hf extend from a middle portion 32hg of the slider 32h. An angularly-extending or ramp surface 32hea and side surfaces 32heb and 32hec are defined by the protrusion 32he, and an angularly-extending or ramp surface 32hfa and side surfaces 32hfb and 32hfc are defined by the protrusion 32hf. The surfaces 32hea and 32hfa are substantially triangle shaped.

A curved surface 32hed extends between the side surfaces 32heb and 32hec, and a curved surface 32hfd extends between the side surfaces 32hfb and 32hfc. A spacing 32hh is defined between the peaks of the curved surfaces 32hed and 32hfd. In an exemplary embodiment, the spacing 32hh may range from about 0.275 inches to about 0.350 inches. In an exemplary embodiment, the spacing 32hh may be about 0.314 inches.

An angle 32hi is defined between the ramp surfaces 32hea and 32hfa. In an exemplary embodiment, the angle 32hi may be about 107.1 degrees. An angle 32hj is defined between the surfaces 32heb and 32hfb, and an angle 32hk is defined between the surfaces 32hec and 32hfc. In an exemplary embodiment, the angle 32hj may be about 120.4 degrees. In an exemplary embodiment, the angle 32hk may be substantially equal to the angle 32hj. In an exemplary embodiment, the angles 32hj and 32hk may each be about 120.4 degrees.

A slot 32hl is formed through the middle portion 32hg, and shoulders 32hm and 32hn are formed at the transition between the middle portion and the end portion 32ha. A contact surface 32hga is defined by the middle portion 32hg, and a projection 32ho extends from the middle portion in a direction opposite that of the protrusions 32he and 32hf. A contact surface 32hoa is defined by the projection 32ho, and a region 32hp is defined between the contact surfaces 32hga and 32hoa. A region 32hq is defined between the end portion 32ha and the projection 32ho. The end portions 32ha and 32hc may define widths 32haa and 32hca, respectively, and a maximum width 32hr of the slider 32h may be defined by the middle portion 32hg. The width 32hca is less than the width 32haa which, in turn, is less than the width 32hr. In an exemplary embodiment, the width 32haa may be equal to the width 32hr. In an exemplary embodiment, the width 32hca may be substantially half of the width 32haa.

In several exemplary embodiments, the slider 32h may be composed of a wide variety of materials. In an exemplary embodiment, the slider 32h may be composed of any material that promotes a substantially smooth sliding engagement with another material such as, for example, any type of metal, without the need for lubrication. In an exemplary embodiment, the slider 32h may be composed of a material that has an inherent lubricity to promote a substantially smooth sliding engagement such as, for example, Celcon GC25A, or a material that is equivalent to Celcon GC25A. In an exemplary embodiment, the slider 32h may be composed of acetal, which has an inherent lubricity to promote a substantially smooth sliding engagement.

In several exemplary embodiments, the remainder of the sliders 32 in the plurality of sliders 32, including the sliders 32a, 32b, 32c, 32d, 32e, 32f and 32g, are substantially similar to the slider 32h and therefore will not be described in detail. In the description below, any reference numerals used to refer to features of the sliders 32a, 32b, 32c, 32d, 32f and 32g will correspond to the reference numerals for the features of the slider 32h, except that the first letter position for the reference numerals used to describe the slider 32h, that is, h, will be replaced by the first letter position of the particular replacement slider, that is, a, b, c, d, e, f or g for the sliders 32a, 32b, 32c, 32d, 32e, 32f or 32g, respectively.

In an exemplary embodiment, as illustrated in FIGS. 9, 10,11 and 12, the operator 16h includes a shaft 16ha including a proximal end portion 16haa, an external threaded connection 16hab, a tapered portion 16hac and a distal end portion 16had, through which a through-hole 16hae extends. The exterior of the proximal end portion 16haa is substantially square-shaped, and an internal threaded connection 16haf extends into the proximal end portion. The shaft 16ha further includes a longitudinal center axis 16hag and an external annular recess 16hah positioned between the external threaded connection 16hab and the tapered portion 16hac.

An o-ring 16hb is disposed in the external annular recess 16hah. A bearing 16hc including an internal threaded connection 16hca is coupled to the shaft 16ha so that the shaft extends through the bearing, with the external threaded connection 16hab being threadably engaged with the internal threaded connection 16hca. As a result, a portion of the external threaded connection 16hab extends outside of the bearing 16hc and the o-ring 16hb forms a sealing engagement between the bearing 16hc and the external annular recess 16hah. In an exemplary embodiment, the external threaded connection 16hab may be threadably engaged with the internal threaded connection 16hca until the shaft 16ha is in a fully-seated position in the bearing 16hc, and then the external threaded connection 16hab is backed out from the fully-seated position in the bearing by a predetermined number of turns. In an exemplary embodiment, the predetermined number of turns may range from about 1 turn to about 4 turns. In an exemplary embodiment, the bearing 16hc extends through the cover 14 and is coupled to the cover in a conventional manner.

A handle 16hd includes a proximal end portion 16hda and an opening 16hdb formed through the proximal end portion, the opening including a square-shaped through-portion 16hdba and a countersunk portion 16hdbb. An angularly-extending portion 16hdc extends from the proximal end portion 16hda and defines an angle 16hdd between the angularly-extending portion and an imaginary plane that is perpendicular to the longitudinal center axis 16hag of the shaft 16ha. In an exemplary embodiment, the angle 16hdd may be about 25.0 degrees.

The proximal end portion 16hda of the handle 16hd fits over the square-shaped proximal end portion 16haa of the shaft 16ha so that the square-shaped proximal end portion 16haa extends into the square-shaped through-portion 16hdba of the opening 16hdb. A washer 16he is received within the countersunk portion 16hdbb of the opening 16hdb and a fastener such as, for example, a screw 16hf extends through the opening 16hdb and is threadably engaged with the internal threaded connection 16haf of the proximal end portion 16haa of the shaft 16ha, thereby connecting the handle 16hd to the shaft 16ha.

A device such as a pin 16hg includes a stem 16hga that extends through the bore 16hae to connect the pin to the shaft 16ha. A cam lobe 16hgb extends from a base 16hgc, and a transition portion 16hgd extends from the base in a direction opposite that of the cam lobe 16hgb. The pin 16hg further includes planar surfaces 16hge and 16hgf spaced in a parallel relation. In an exemplary embodiment, the planar surfaces 16hge and 16hgf may be formed by removing material from the cam lobe 16hgb, the base 16hgc and/or the transition portion 16hgd.

In an exemplary embodiment, as shown in FIG. 9, the pin 16hg extends from the shaft 16ha so that the pin and the handle 16hd are aligned, that is, both the pin 16hg and the handle 16hd extend in the same direction from the center axis 16hag of the shaft 16ha. In an exemplary embodiment, the pin 16hg and the handle 16hd may be un-aligned, that is the pin and the handle may extend in different directions from the center axis 16hag of the shaft 16ha. For example, the pin 16hg and the handle 16hd may extend from the center axis 16hag of the shaft 16ha in directions that are 180 degrees apart, that is, the pin and the handle may extend in opposing directions.

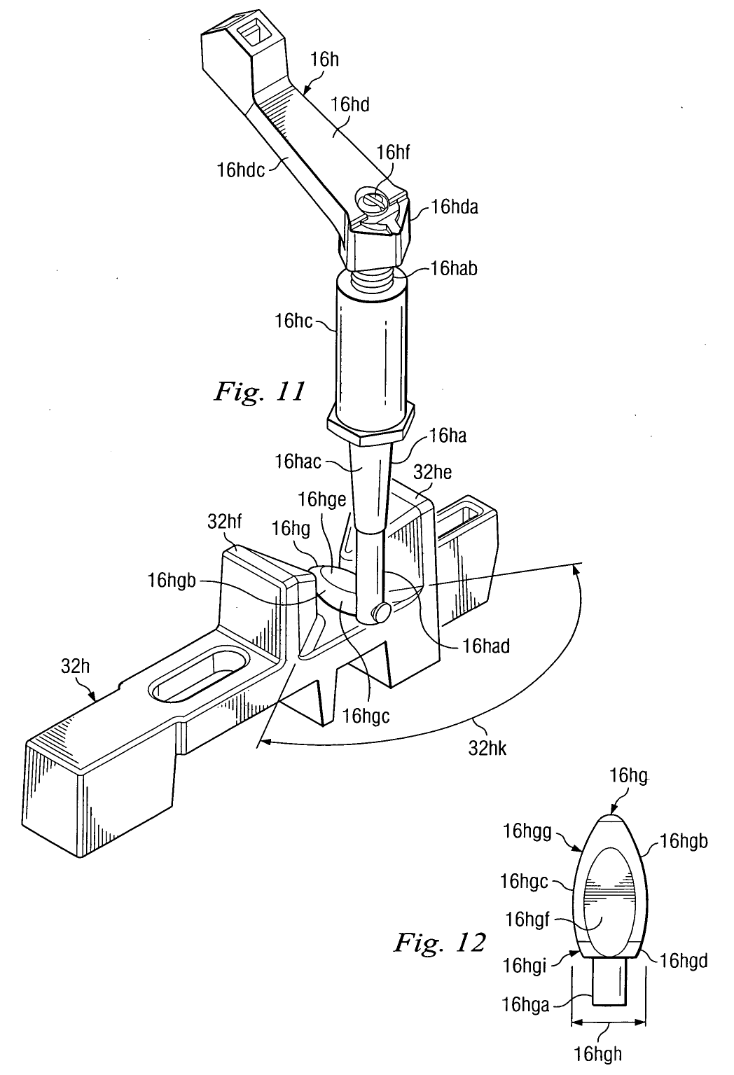

In an exemplary embodiment, as shown in FIG. 11, the operator 16h is aligned with the slider 32h, when the cover 14 is closed and secured to the enclosure body 12, so that the pin 16hg is permitted to extend between the protrusions 32he and 32hf of the slider 32h under conditions to be described, with the pin at least partially extending within the spacing 32hh, and at least partially extending within a region defined by the angle 32hk.

In an exemplary embodiment, as shown in FIG. 12, the cam lobe 16hgb defines a radius 16hgg, the base 16hgc defines a diameter 16hgh, and the transition portion 16hgd defines a radius 16hgi. In an exemplary embodiment, the radius 16hgg may range from about 0.5 inches to about 1 inch. In an exemplary embodiment, the radius 16hgg may be about 0.750 inches. In an exemplary embodiment, the diameter 16hgh may range from about 0.2 inches to about 0.5 inches. In an exemplary embodiment, the diameter 16hgh may be about 0.352 inches. In an exemplary embodiment, the radius 16hgi may be about 0.313 inches.

In several exemplary embodiments, the remainder of the operators 16 in the plurality of operators 16, including the operators 16a, 16b, 16c, 16d, 16e, 16f and 16g, are substantially similar to the operator 16h and therefore will not be described in detail. In the description below, any reference numerals used to refer to features of the operators 16a, 16b, 16c, 16d, 16f and 16g will correspond to the reference numerals for the features of the operator 16h, except that the first letter position for the reference numerals used to describe the operator 16h, that is, h, will be replaced by the first letter position of the particular replacement operator, that is, a, b, c, d, e, f or g for the operators 16a, 16b, 16c, 16d, 16e, 16f or 16g, respectively.

In several exemplary embodiments, when the cover 14 is closed and secured to the enclosure body 12, the operators 16a, 16b, 16c, 16d, 16e, 16f, 16g are aligned with the sliders 32a, 32b, 32c, 32d, 32e, 32f and 32g, respectively, in a manner similar to the manner in which the operator 16h is aligned with the slider 32h.

In several exemplary embodiments, the remainder of the operators 16 and sliders 32 shown in FIGS. 1 and 2, and the respective circuit breakers 28 hidden from view and beneath the respective sliders 32, and the arrangements therebetween, are substantially similar to the above-described operators 16a, 16b, 16c, 16d, 16e, 16f, 16g and 16h, the sliders 32a, 32b, 32c, 32d, 32e, 32f, 32g and 32h, and the circuit breakers 28a, 28b, 28c, 28d, 28e, 28f, 28g and 28h, and the arrangements therebetween, respectively.

In several exemplary embodiments, the arrangement of the circuit breakers 28, the sliders 32 and the operators 16 may vary widely, and the quantity of each may be modified. In an exemplary embodiment, one or more of the operators 16a, 16b, 16c, 16d, 16e, 16f, 16g and 16h, the sliders 32a, 32b, 32c, 32d, 32e, 32f, 32g and 32h, and/or the circuit breakers 28a, 28b, 28c, 28d, 28f, 28g and 28h may be removed from the panelboard 10. In an exemplary embodiment, the quantity of the circuit breakers in the plurality of circuit breakers 28 may be increased, which may necessitate a modification of the plate member 30, the strip 34, the enclosure body 12 and/or the cover 14, and which may further necessitate a corresponding increase in the quantity of the operators 16 and/or the sliders 32.

In an exemplary embodiment, when the panelboard 10 is in its assembled condition as illustrated in FIGS. 13A and 13B, the circuit breakers 28a, 28b, 28c, 28d, 28e, 28f, 28g and 28h are arranged in a symmetric configuration, with the circuit breakers 28a, 28c, 28e and 28g symmetric to the circuit breakers 28b, 28d, 28f and 28h, respectively, about the center bar 30e. However, the sliders 32a, 32b, 32c, 32d, 32e, 32f, 32g and 32h are not arranged in a symmetric configuration because of the polarity associated with each of the end portions 32ac, 32bc, 32cc, 32dc, 32ec, 32fc, 32gc and 32hc. That is, the sliders 32a, 32c, 32e and 32g are not symmetric to the sliders 32b, 32d, 32f and 32h, respectively, about the center bar 30e. Instead, the sliders 32a, 32c, 32e and 32g are oriented so that they are rotated 180 degrees from the sliders 32b, 32d, 32f and 32h, respectively, about an imaginary axis that is parallel to the center axis 16hag of the shaft 16ha of the operator 16 when the cover 14 is closed and secured to the enclosure body 12.

In an exemplary embodiment, each of the circuit breakers in the plurality of circuit breakers 28 may be in the form of a wide variety of circuit breakers. As shown in FIGS. 13A and 13B, the circuit breakers 28a, 28b, 28c and 28d are in the form of standard circuit breakers and the circuit breakers 28e, 28f, 28g and 28h are in the form of GFI circuit breakers, and include breaker test buttons 36, 38, 40 and 42, respectively. In an exemplary embodiment, the circuit breakers 28e, 28f, 28g and 28h may be in the form of EPD circuit breakers. The circuit breaker 28g includes a switch 28ga. In an exemplary embodiment, one or more of the circuit breakers 28a, 28b, 28c, 28d, 28e, 28f, 28g and 28h may be in the form of Cutler Hammer BAB Series Breakers.

Due to the above-described extension of the pin 16hg of the operator 16 between the protrusions 32he and 32hf of the slider 32h, the center axis 16hag of the shaft 16ha of the operator 16h is spaced from the centerline of the switch 28ha which, in turn, is collinear with the centerline of the slider 32h, by a predetermined spacing 44. In an exemplary embodiment, the centerline line of the switch 28ha may be collinear with both the centerline of the circuit breaker 28h and the centerline of the slider 32h. In an exemplary embodiment, the predetermined spacing 44 may be about 0.5 inches, and the corresponding spacings between the centerlines of the switches of the circuit breakers 28a, 28b, 28c, 28d, 28e, 28f and 28g and the center axes 16aag, 16bag, 16cag, 16dag, 16eag, 16fag and 16gag, respectively, may also be about 0.5 inches. In an exemplary embodiment, the center axis 16hag of the shaft 16ha of the operator 16h may extend between the circuit breakers 28f and 28h. In an exemplary embodiment, the circuit breakers 28f and 28h are positioned in a compact arrangement in which the circuit breakers contact or nearly contact each other, and the center axis 16hag extends between the circuit breakers 28f and 28h by extending along the imaginary plane of contact or near contact between the circuit breakers. In an exemplary embodiment, the circuit breaker 28h may define a width 45. In an exemplary embodiment, the spacing 44 may be substantially equal to about half of the width 45, thereby accommodating the compact arrangement between the circuit breakers 28f and 28h. In an exemplary embodiment, the width 45 may be about 1 inch and the spacing 44 may be about 0.5 inches. In an exemplary embodiment, the width 45 may be about 3 inches and the spacing 44 may be about 1.5 inches.

The angularly-extending portions 16adc and 16bdc of the handles 16ad and 16bd, respectively, permit the handles 16cd and 16dd, respectively, to extend beneath the angularly-extending portions, thereby nesting with the handles 16ad and 16bd, respectively. Likewise, the angularly-extending portions 16edc and 16fdc of the handles 16ed and 16fd, respectively, permit the handles 16gd and 16hd, respectively, to extend beneath the angularly-extending portions, thereby nesting with the handles 16ed and 16fd, respectively, in order to, for example, accommodate the compact arrangement between the circuit breakers 28f and 28h. Although not shown in FIG. 13A, all of the handles of the operators 16 that are positioned below the operators 16a and 16b are permitted to nest, in a manner similar to the foregoing, with corresponding handles immediately thereabove.

In an exemplary embodiment, the operators 16a, 16b, 16c, 16d, 16e, 16f, 16g and 16h are aligned with the sliders 32a, 32b, 32c, 32d, 32e, 32f, 32g and 32h, without staggering the operators 16, that is, without offsetting the operators 16 to the left or right of each other as viewed in FIG. 13A, so that the relative positions of the operators 16 correspond to the relative positions of the respective sliders 32 and thus the relative positions of the respective circuit breakers 28. In an exemplary embodiment, this correspondence may facilitate the operation of the sliders 32, and the respective circuit breakers 28, by, for example, enabling an operator of the panelboard 10 to quickly and easily determine which operator 16 controls which circuit breaker 28. In several exemplary embodiments, this correspondence between the operators 16 and the respective sliders 32 and circuit breakers 28 is possible even when each circuit breaker 28 that is positioned directly beneath another circuit breaker 28 contacts or nearly contacts the another circuit breaker 28, thereby accommodating a compact arrangement of the circuit breakers 28.

During operation, each of the circuit breakers 28a, 28b, 28c and 28d may be in one of at least four operational modes: an on operational mode, a trip operational mode, an off operational mode, and a reset operational mode. Correspondingly, each of the switches of the circuit breakers 28a, 28b, 28c and 28d, and the sliders 32a, 32b, 32c and 32d, may be in one of at least four positions: an on position, a trip position, an off position, and a reset position. In an exemplary embodiment, the reset operational mode of the circuit breakers 28a, 28b, 28c and 28d may be a temporary mode. Each of the circuit breakers 28e, 28f, 28g and 28h may be in one of at least four operational modes: an on operational mode, a trip operational mode, an off operational mode, and a reset operational mode. Correspondingly, each of the switches of the circuit breakers 28e, 28f, 28g and 28h, including each of the switches 28ga and 28ha of the circuit breakers 28g and 28h, respectively, may be in one of at least four operational positions: an on position, a trip position, an off position, and a reset position. Moreover, each of the sliders 32e, 32f, 32g and 32h may be in one of at least four corresponding operational positions: an on position, a trip position, an off position, and a reset position. In an exemplary embodiment, the trip positions of the sliders 32 are shown in FIG. 2. In an exemplary embodiment, the reset operational mode of the circuit breakers 28e, 28f, 28g and 28h may be a temporary mode.

In exemplary embodiment, as shown in FIGS. 13A and 13B, the circuit breakers 28a, 28b, 28c, 28d, 28e, 28f, 28g and 28h are each initially in the on operational mode. As a result, the switches 28ga and 28ha, and the sliders 32g and 32h, are each initially in the on position. The switch 28ha extends into the region 32hp and the contact surface 32hoa engages the switch. Similarly, the switch 28ga extends into the region 32gp and the contact surface 32goa engages the switch. The buttons 40 and 42 extend into the regions 32gq and 32hq, respectively. In an exemplary embodiment, the engagement between the switch 28ha and the contact surface 32hoa may prevent the slider 32h from moving any further to the left, and the engagement between the switch 28ga and the contact surface 32goa may prevent the slider 32g from moving any further to the right. In an exemplary embodiment, the engagement between the projection 30eaa and the slider 32h may prevent the slider 32h from moving any further to the left, and the engagement between a respective projection in the plurality of projections 30ea and the slider 32g may prevent the slider 32g from moving any further to the right. In an exemplary embodiment, the engagement between the projection 34caa and the slider 32h may prevent the slider 32h from moving any further to the left, and the engagement between a respective projection in the plurality of projections 34ca and the slider 32g may prevent the slider 32g from moving any further to the right. The relative positions of the sliders 32a and 32b, 32c and 32d, and 32e and 32f, are similar to the relative positions of the sliders 32g and 32h and therefore will not be described in detail.

The handle 16hd is angularly positioned so that an angle 46 is defined between a centerline of the handle and an imaginary vertical line that is parallel to the center bar 30e. In an exemplary embodiment, the angle 46 is about 29 degrees. The angular position of the handle 16fd is identical to the angular position of the handle 16hd, and the angular positions of the handles 16ed and 16gd are symmetric to the handles 16fd and 16hd, respectively, about the center bar 30e.

The handle 16bd is angularly positioned so that an angle 48 is defined between a centerline of the handle and an imaginary vertical line that is parallel to the center bar 30e. In an exemplary embodiment, the angle 48 is about 23 degrees. The angular position of the handle 16dd is identical to the angular position of the handle 16ad, and the angular positions of the handles 16ad and 16cd are symmetric to the handles 16bd and 16dd, respectively, about the center bar 30e.

In an exemplary embodiment, the handles 16ad, 16c, 16ed and 16gd are prevented from rotating any further in a counterclockwise direction by the wall 18b of the lockout plate 18, and the handles 16bd, 16dd, 16fd and 16hd are prevented from rotating any further in a clockwise direction by the wall 20a of the lockout plate 20. In an exemplary embodiment, devices such as, for example, locks, may be connected to the lockout plates 18 and/or 20 in order to prevent any rotation in any direction of one or more of the handles of the operator 16.

In several exemplary embodiments, the values of the angles 46 and 48 may be equal and/or may vary widely and may be dependent upon a wide variety of factors such as, for example, the design and/or manufacturer of the respective circuit breaker. Moreover, the value of each angle between an imaginary vertical line that is parallel to the center bar 30e and a handle of an operator 16 may be different than one or more of the other handles of the other operators 16.

The sliders 32g and 32h are positioned, relative to the plate member 30, so that the end portions 32gc and 32hc overlap, enabling the sliders to be positioned relatively close to one another when the respective circuit breakers 28g and 28h are in the on position. The sliders 32a and 32b, 32c and 32d, and 32e and 32f, are positioned in a manner similar to the sliders 32g and 32h, respectively.

The slot 32hl of the slider 32h permits access to the button 42 when the circuit breaker 28h is in its on position. In an exemplary embodiment, when the circuit breaker 28h is in its on position, the button 42 may be activated in a conventional manner and/or using any conventional device such as, for example, using a conventional pushbutton or plunger extending through and coupled to the cover 14, and at least partially extending within the slot 32hl. Similarly, the slots 32el, 32fl and 32gl permit access to the buttons 36, 38 and 40, respectively, when the respective circuit breakers 28e, 28f and 28g are in their on position. In an exemplary embodiment, if the circuit breakers 28a, 28b, 28c and 28d included breaker test buttons, then the slots 32al, 32bl, 32cl and 32dl would permit access to the respective test buttons.

In an exemplary embodiment, to change the operational mode of the circuit breaker 28h from the on operational mode as illustrated in FIGS. 13A and 13B to an off operational mode as illustrated in FIGS. 14A and 14B, the slider 32h is actuated when the cover 14 is closed and secured to the enclosure body 12. More particularly, the handle 16hd of the operator 16h is rotated counterclockwise so that the shaft 16ha rotates in place about its longitudinal center axis 16hag. In an exemplary embodiment, the handle 16hd is permitted to rotate, without interfering with the handle 16fd of the operator 16f, because of the above-described nesting arrangement between the handles 16fd and 16hd. In an exemplary embodiment, the bearing 16hc supports the shaft 16ha before, during and after the rotation of the shaft.

As a result of the rotation of the handle 16hd and the shaft 16ha, the pin 16hg rotates counterclockwise along with the shaft 16ha. During the rotation of the pin 16hg, the cam lobe 16hgb cammingly engages the protrusion 32hf, thereby actuating the slider 32h. Due to this actuation, the slider 32h is forced to slide to the right, as viewed in FIG. 13A, relative to and slidingly engaging the plate member 30, and translate away from the center bar 30e. In an exemplary embodiment, the slider 32h may slidingly engage the U-shaped center bar 30e of the plate member 30 and a surface of the wall 30b of the plate member 30 that is defined by the opening 30baa. In an exemplary embodiment, during the camming engagement between the cam lobe 16hgb and the protrusion 32hf, the cam lobe may contact and slidingly engage the surfaces 32hfc and/or 32hfd of the protrusion. Moreover, during the camming engagement between the cam lobe 16hg and the protrusion 32hf, the cam lobe may contact and slidingly engage the surfaces 32hec and/or 32hed of the protrusion 32he.

In an exemplary embodiment, during the rotation of the pin 16hg, the planar surface 16hgf of the pin 16hg remains positioned proximate the slider 32h and may slidingly engage the slider 32h in the region defined by the angle 32hk.

In an exemplary embodiment, during the translation of the slider 32h and the resulting sliding engagement between the slider and the plate member 30, the projections 30eaa and 34caa may guide the slider, thereby facilitating a substantially straight direction of translation and substantially preventing any unwanted interference between the slider 32h and the slider 32f and/or the any other components in the vicinity of the slider 32h. The wall member 30b may also facilitate the guidance of the slider 32h because of the extension of the end portion 32ha through the opening 30baa.

In an exemplary embodiment, during the counterclockwise rotation of the operator 16 including the rotation of the handle 16hd, the shaft 16ha and the pin 16hg, and the resulting translation of the slider 32h, the contact surface 32hga of the middle portion 32hg of the slider 32h applies a force against the switch 28ha of the circuit breaker 28h, thereby placing the switch in the off operational position and placing the circuit breaker in the off operational mode.

In an exemplary embodiment, any further translation of the slider 32h in a direction away from the center bar 30e may be prevented by the engagement between the contact surface 32hga and the switch 28ha. In an exemplary embodiment, any further translation of the slider 32h in a direction away from the center bar 30e may be prevented by the engagement of the shoulders 32hm and 32hn of the slider 32h with the wall 30b of the plate member 30. In an exemplary embodiment, any further rotation of the handle 16hd and the resulting translation of the slider 32h may be prevented by the engagement of the handle 16hd with the wall 20b of the lockout plate 20.

In an exemplary embodiment, the sliders 32b, 32d and 32f are actuated, in a direction away from the center bar 30e, in a manner similar to the manner in which the slider 32h is actuated and therefore the actuation of the sliders 32b, 32d and 32f will not be described in detail. In an exemplary embodiment, the sliders 32a, 32c, 32e and 32g are actuated, in a direction away from the center bar 30e, in a manner similar to the manner in which the sliders 32b, 32d, 32f and 32h, respectively, are actuated and therefore the actuation of the sliders 32b, 32d, 32f and 32h will not be described in detail. However, the respective operators 16a, 16c, 16e and 16g are rotated clockwise, rather than counterclockwise, due to the above-described symmetric arrangement between the handles 16ad, 16cd, 16ed and 16gd, and the handles 16bd, 16dd, 16fd and 16hd, respectively. Moreover, the operational modes of the circuit breakers 28b, 28d and 28f are changed from their respective on operational modes to their respective off operational modes in a manner substantially similar to the manner in which the operational mode of the circuit breaker 28h is changed from its on operational mode to its off operational mode.

In exemplary embodiment, once the circuit breakers 28a, 28b, 28c, 28d, 28e, 28f, 28g and 28h are placed in their off operational modes, as illustrated in FIGS. 14A and 14B, the switches 28ga and 28ha, and the sliders 32g and 32h, are in their off positions. More particularly, the switch 28ha extends into the region 32hp and the contact surface 32hga of the middle portion 32hg of the slider 32h engages the switch. Similarly, the switch 28ga extends into the region 32gp and the contact surface 32gga engages the switch. In an exemplary embodiment, the engagement between the switch 28ha and the contact surface 32hga may prevent the slider 32h from moving any further to the right, and the engagement between the switch 28ga and the contact surface 32gga may prevent the slider 32g from moving any further to the left. In exemplary embodiment, the engagement between the projection 30eaa and the slider 32h may prevent the slider 32h from moving any further to the right, and the engagement between a respective projection in the plurality of projections 30ea and the slider 32g may prevent the slider 32g from moving any further to the left. In an exemplary embodiment, the engagement between the projection 34caa and the slider 32h may prevent the slider 32h from moving any further to the right, and the engagement between a respective projection in the plurality of projections 34ca and the slider 32g may prevent the slider 32g from moving any further to the left. The relative positions of the sliders 32a and 32b, 32c and 32d, and 32e and 32f, are similar to the relative positions of the sliders 32g and 32h and therefore will not be described in detail.

The handle 16hd is angularly positioned so that an angle 50 is defined between a centerline of the handle and an imaginary vertical line that is parallel to the center bar 30e. In an exemplary embodiment, the angle 50 is about 33 degrees. The angular position of the handle 16fd is identical to the angular position of the handle 16hd, and the angular positions of the handles 16ed and 16gd are symmetric to the handles 16fd and 16hd, respectively, about the center bar 30e.

The handle 16bd is angularly positioned so that an angle 52 is defined between a centerline of the handle and imaginary vertical line that is parallel to the center bar 30e. In an exemplary embodiment, the angle 52 is about 27 degrees. The angular position of the handle 16dd is identical to the angular position of the handle 16ad, and the angular positions of the handles 16ad and 16cd are symmetric to the handles 16bd and 16dd, respectively, about the center bar 30e.

In several exemplary embodiments, the value of the angles 50 and 52 may be equal and/or may vary widely and may be dependent upon a wide variety of factors such as, for example, the design and/or manufacturer of the respective circuit breaker. Moreover, the value of each angle between an imaginary vertical line that is parallel to the center bar 30e and a handle of an operator 16 may be different than one or more of the other handles of the other operators 16.

The sliders 32g and 32h are positioned, relative to the plate member 30, so that the end portions 32gc and 32hc continue to overlap when the circuit breakers 28g and 28h are in their off operational modes, but not to the extent with which the end portions 32gc and 32hc overlap when the circuit breakers 28g and 28h are in their on operational modes. The sliders 32a and 32b, 32c and 32d, and 32e and 32f, are positioned in a manner similar to the sliders 32g and 32h, respectively.

The slot 32hl of the slider 32h continues to permit access to the button 42 when the circuit breaker 28h is in its off operational mode. In an exemplary embodiment, a device for activating the button 42 such as, for example, a conventional pushbutton or plunger extending through and coupled to the cover 14, may continue to at least partially extend in the slot 32hl when the circuit breaker 28h is in its off operational mode. Similarly, the slots 32el, 32fl and 32gl permit access to the buttons 36, 38 and 40, respectively, when the respective circuit breakers 28e, 28f and 28g are in their off operational modes. In an exemplary embodiment, if the circuit breakers 28a, 28b, 28c and 28d included breaker test buttons, then the slots 32al, 32bl, 32cl and 32dl would permit access to the respective test buttons.

In an exemplary embodiment, the reset operational positions of the switches 28ea, 28fa, 28ga and 28ha, and the sliders 32e, 32f, 32g and 32h, may be equivalent to their respective off operational positions. As a result, the slots 32el, 32fl, 32gl and 32hl continue to permit access to the buttons 36, 38, 40 and 42, respectively, when the circuit breakers 28e, 28f, 28g and 28h are in their reset operational modes. In an exemplary embodiment, a device for activating the button 42 such as, for example, a conventional pushbutton or plunger extending through and coupled to the cover 14, may continue to at least partially extend in the slot 32hl when the circuit breaker 28h is in its reset operational mode.

In an exemplary embodiment, the handles 16bd and 16dd may be further rotated in a counterclockwise direction to continue to apply a force to and operate the switches 28aa and 28ba, respectively, to place the circuit breakers 28a and 28b, respectively, in their reset operational modes. In an exemplary embodiment, if the handles 16bd and 16dd are so rotated to place the circuit breakers 28a and 28b in their reset operational modes, then the value of the angle 50 may increase. In an exemplary embodiment, the value of the angle 50 may increase to about 30 degrees. In an exemplary embodiment, if the circuit breakers 28a, 28b, 28c and 28d included breaker test buttons, then the slots 32al, 32bl, 32cl and 32dl would continue to permit access to the respective test buttons when the circuit breakers 28a, 28b, 28c and 28d were placed in their reset operational modes.

In several exemplary embodiments, the values of the angles 50 and 52 may be equal and/or may vary widely and may be dependent upon a wide variety of factors such as, for example, the design and/or manufacturer of the respective circuit breaker. Moreover, the value of each angle between an imaginary vertical line that is parallel to the center bar 30e and a handle of an operator 16 may be different than one or more of the other handles of the other operators 16.

In an exemplary embodiment, when the circuit breakers 28a, 28b, 28c, 28d, 28e, 28f, 28g and 28h are in their reset operational modes, the handles 16ad, 16cd, 16ed and 16gd are prevented from rotating any further in a clockwise direction by the wall 18a of the lockout plate 18, and the handles 16bd, 16dd, 16fd and 16hd are prevented from rotating any further in a counterclockwise direction by the wall 20b of the lockout plate 20. In an exemplary embodiment, devices such as, for example, locks, may be connected to the lockout plates 18 and/or 20 in order to prevent any rotation in any direction of one or more of the handles of the operator 16.

In an exemplary embodiment, if it is desired to place one or more of the circuit breakers 28a, 28b, 28c, 28d, 28e, 28f, 28g and 28h in their on operational modes, the above-described steps are carried out in reverse, that is, the handles 16ad, 16cd, 16ed and 16gd are rotated counterclockwise and the handles 16bd, 16dd, 16fd and 16hd are rotated clockwise, so that the respective sliders 32 are actuated and the respective switches of the circuit breakers 28, the respective operators 16 and the respective sliders 32 are again placed in the positions shown in FIGS. 13A and 13B. In an exemplary embodiment, one or more of the circuit breakers 28a, 28b, 28c, 28d, 28e, 28f, 28g and 28h may be placed in their trip operational modes by, for example, the one or more of the circuit breakers 28 electrically tripping during normal circuit-breaker operation. In an exemplary embodiment, the circuit breakers 28e, 28f, 28g and/or 28h may be placed in their trip operational modes, from their on operational modes, as a result of, for example, the buttons 36, 38, 40 and/or 42, respectively, being pressed or the circuit breakers 28e, 28f, 28g and/or 28h electrically tripping. As a result, the handles 16ed and/or 16gd rotate clockwise and the handles 16f and/or 16hd rotate counterclockwise, and the respective sliders 32 are placed in their trip positions, that is, between their respective off and on positions, as shown in FIG. 2, and the switches of the circuit breakers 28 are placed in their trip positions, that is, extending in straight directions that are perpendicular to the respective circuit breakers 28, so that the angle 46 is about 0 degrees. In an exemplary embodiment, the slot 32hl of the slider 32h continues to permit access to the button 42 when the circuit breaker 28h is in its trip operational mode. In an exemplary embodiment, a device for activating the button 42 such as, for example, a conventional pushbutton or plunger extending through and coupled to the cover 14, may continue to at least partially extend in the slot 32hl when the circuit breaker 28h is in its trip operational mode. Similarly, the slots 32el, 32fl and 32gl permit access to the buttons 36, 38 and 40, respectively, when the respective circuit breakers 28e, 28f and 28g are in their trip operational modes. In an exemplary embodiment, if the circuit breakers 28a, 28b, 28c and 28d included breaker test buttons, then the slots 32al, 32bl, 32cl and 32dl would permit access to the respective test buttons. In an exemplary embodiment, the initial operational mode of the circuit breaker 28h, and the above-described order in which the circuit breaker 28h is placed in its different operational modes, is arbitrarily chosen for illustration purposes, and a wide variety of initial conditions and/or operational orders is possible for the circuit breaker 28h. In several exemplary embodiments, the circuit breakers 28a, 28b, 28c, 28d, 28e, 28f, 28g and 28h may each initially be placed in any one of the above-described operational modes of the circuit breakers 28, and such initial operational modes may be changed to any other of the above-described operational modes of the circuit breakers 28, and so on, in a wide variety of orders of operational modes.

In an exemplary embodiment, the above-described close alignment of the operators 16a, 16b, 16c, 16d, 16e, 16f, 16g and 16h with the sliders 32a, 32b, 32c, 32d, 32e, 32f, 32g and 32h, respectively, does not interfere with the ability of a slider to permit access to a breaker test button, if present on a respective circuit breaker 28, at any one of the operational modes of the respective circuit breaker. Thus, access to a breaker test button, if present, is always permitted across the full range of motion of a respective slider in the plurality of sliders 32. As a result, in an exemplary embodiment, a device for activating the button 42 such as, for example, a conventional pushbutton or plunger extending through and coupled to the cover 14, may always at least partially extend in the slot 32hl, and the slider 32h may translate relative thereto, during all of the operational modes of the circuit breaker 28h, including the on, trip, off and reset operational modes, thereby reducing the amount of travel needed for the pushbutton or plunger to activate the button 42, and/or decreasing the likelihood that the pushbutton or plunger will damage the slider 32h before, during and/or after the activation of the button 42. In an exemplary embodiment, in addition to, or instead of the slot 32hl, one or more other openings such as, for example, one or more holes, may be formed in the slider 32h to permit access to the to the button 42 during all of the operational modes of the circuit breaker 28h.

In an exemplary embodiment, the cover 14 may be opened, exposing the chamber 22 of the enclosure body 12 to view, while the circuit breakers 28a, 28b, 28c, 28d, 28e, 28f, 28g and 28h remain in their off operational modes as shown in FIGS. 14A and 14B, and the respective sliders 32a, 32b, 32c, 32d, 32e, 32f, 32g and 32h remain in the positions shown in FIGS. 14A and 14B.

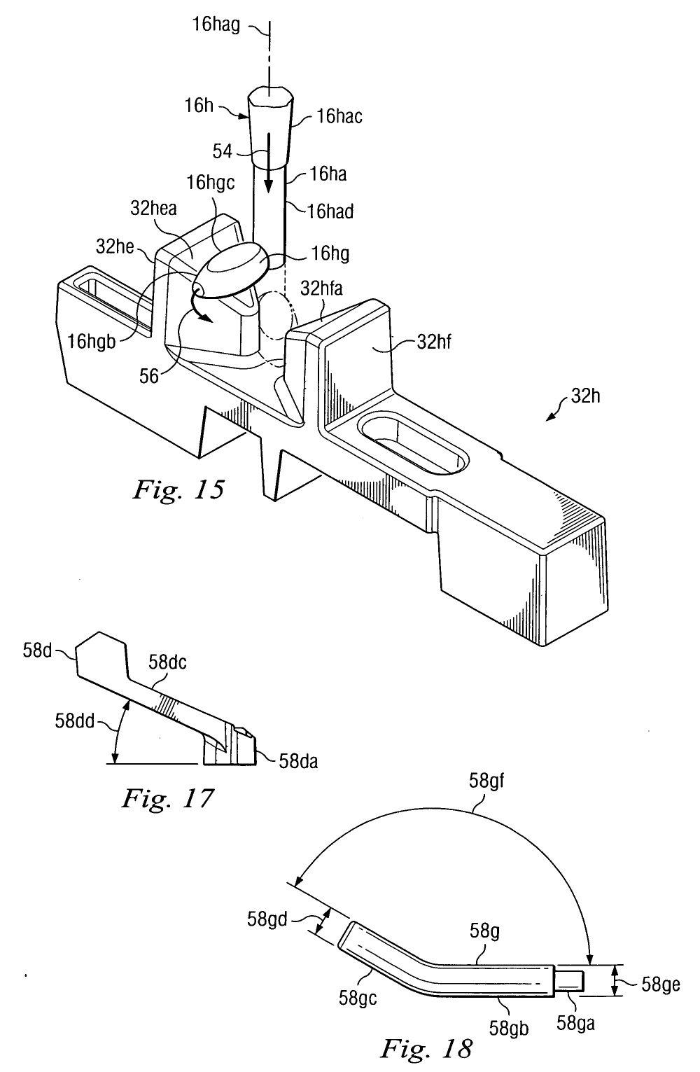

In an exemplary embodiment, as illustrated in FIG. 15, when the cover 14 is opened, the operator 16h is moved away from the slider 32h and the pin 16hg of the operator 16h no longer extends between the protrusions 32he and 32hf of the slider 32h, while the position of the slider 32h remains unchanged. During the movement of the operator 16h away from the slider 32h, in an exemplary embodiment, gravity may cause the pin 16hg to rotate about the center axis 16hag of the shaft 16ha because the pin no longer extends between or is supported by the protrusions 32he and/or 32hf. If the slider 32h is in an off position corresponding to the off operational position of the switch 28ha of the circuit breaker 28h, then the pin 16hg may rotate clockwise until the pin extends downward in a direction perpendicular to the direction of translation of the slider 32h. The cover 14 may then be closed, during which time the operator 16h moves back towards the slider 32h, as shown in FIG. 15. During this movement, the shaft 16ha of the operator 16h approaches the slider 32h, as indicated by an approach arrow 54, and the pin 16hg accordingly approaches the slider while still extending downward in a direction that is perpendicular to the direction of translation of the slider. The pin 16hg contacts the ramp surface 32hea. The engagement between the ramp surface 32hea and the pin 16hg, including the base 16hgc and/or the cam lobe 16hgb, and the continuing approach of the shaft 16ha, causes the pin to rotate in a counterclockwise direction, about the shaft 16ha and as indicated by a rotation arrow 56, and simultaneously slide along and off of the ramp surface, as the shaft 16ha continues its approach as indicated by the arrow 54, until the pin at least partially extends between the protrusions 32he and 32hf and the planar surface 16hgf is proximate or contacting the slider 32. As a result, in response to the closing of the cover 14, the operator 16h automatically adjusts to a position corresponding to the off operational mode of the circuit breaker 28h, the off operational position of the switch 28ha and the corresponding off position of the slider 32h, so that the positions of the switch 28ha and the slider 32h remain unchanged and constant after the engagement of the operator 16h with the slider 32h. In an exemplary embodiment, after the self adjustment of the operator 16h, the slider 32h may be actuated using the operator 16h, as described above. For example, if the operator 16h automatically adjusted to the position shown in FIG. 15, that is, corresponding to the off position of the slider 32h, the handle 16hd could then be rotated clockwise to actuate the slider 32h and place the slider in its on position.

In an exemplary embodiment, if the circuit breaker 28h was in its on operational mode, the switch 28ha was in its on operational position, and the slider 32h was in a position corresponding to the operational position of the switch, then the pin 16hg would instead contact the ramp surface 32hfa and rotate clockwise in response to the approach of the shaft 16ha towards the slider. During and upon the closing of the cover 14, the operator 16 would automatically adjust to a position corresponding to the on operational mode of the circuit breaker 28h, the on operational position of the switch 28ha and the corresponding on position of the slider 32h, so that the positions of the switch 28ha and the slider 32h remain unchanged and constant after the engagement of the operator 16h with the slider 32h.

In an exemplary embodiment, during the closing of the cover 14, the engagement of the operators 16a, 16b, 16c, 16d, 16e, 16f and 16g with the sliders 32a, 32b, 32c, 32d, 32e, 32f and 32g, respectively, is substantially similar to the above-described engagement between the operator 16h and the slider 32h and therefore will not be described in detail. In an exemplary embodiment, in addition to being placed in positions that correspond to the on and off operational modes of the circuit breakers 28a, 28b, 28c and 28d, the operators 16a, 16b, 16c and 16d may automatically adjust to positions that correspond to the reset operational modes of the respective circuit breakers upon the closing of the cover 14.

In an exemplary embodiment, during and upon the closing of the cover 14, the operators 16 self locate with the respective sliders 32, automatically adjusting to the position of each respective slider 32, regardless of the operational mode of the respective circuit breaker 28.

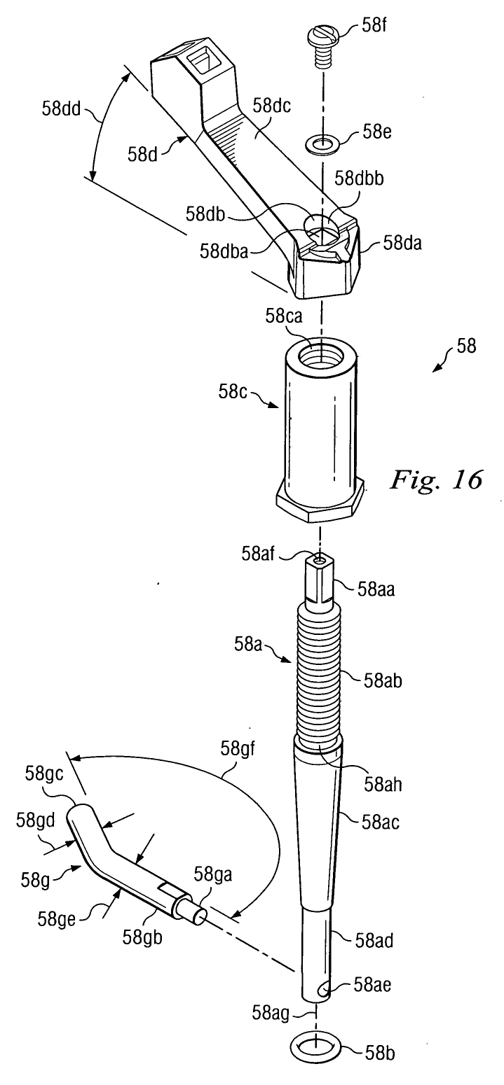

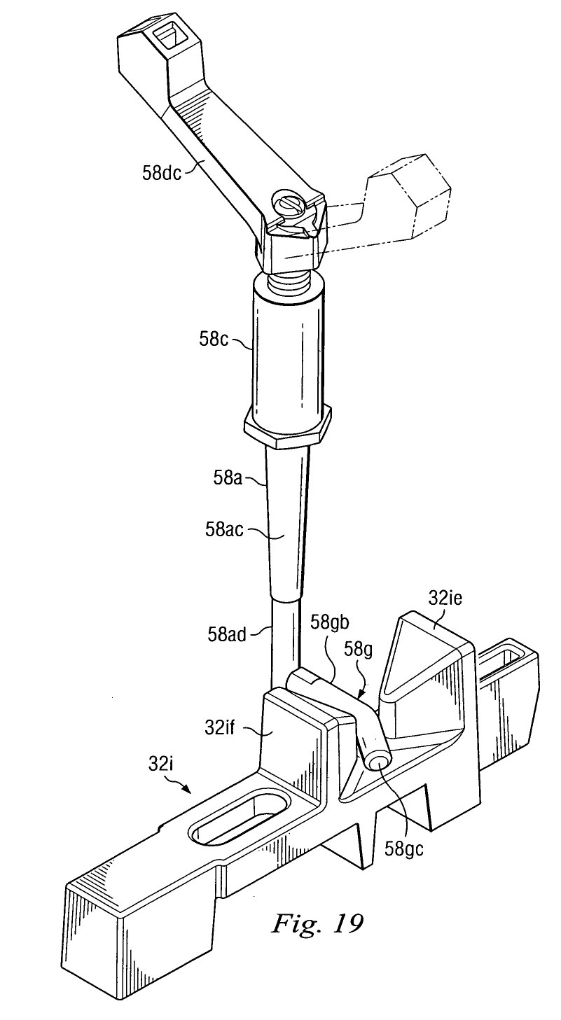

In an exemplary embodiment, as illustrated in FIG. 16, another embodiment of an operator is generally referred to by the reference numeral 58 and includes a shaft 58a including a proximal end portion 58aa, an external threaded connection 58ab, a tapered portion 58ac and a distal end portion 58ad, through which a through-hole 58ae extends. The exterior of the proximal end portion 58aa is substantially square-shaped, and an internal threaded connection 58af extends into the proximal end portion. The shaft 58a further includes a longitudinal center axis 58ag and an external annular recess 58ah positioned between the external threaded connection 58ab and the tapered portion 58ac.

An o-ring 58b is disposed in the external annular recess 58ah. A bearing 58c including an internal threaded connection 58ca is coupled to the shaft 58a so that the shaft extends through the bearing, with the external threaded connection 58ab being threadably engaged with the internal threaded connection 58ca. As a result, a portion of the external threaded connection 58ab extends outside of the bearing 58c and the o-ring 58b forms a sealing engagement between the bearing 58c and the external annular recess 58ah. In an exemplary embodiment, the external threaded connection 58ab may be threadably engaged with the internal threaded connection 58ca until the shaft 58a is in a fully-seated position in the bearing 58c, and then the external threaded connection 58ab is backed out from the fully-seated position in the bearing by a predetermined number of turns. In an exemplary embodiment, the predetermined number of turns may range from about 1 turn to about 4 turns. In an exemplary embodiment, the bearing 58c extends through the cover 14 and is coupled to the cover in a conventional manner.

A handle 58d includes a proximal end portion 58da and an opening 58db formed through the proximal end portion, the opening including a square-shaped through-portion 58dba and a countersunk portion 58dbb. An angularly-extending portion 58dc extends from the proximal end portion 58da and defines an angle 58dd between the angularly-extending portion and an imaginary plane that is perpendicular to the longitudinal center axis 58ag of the shaft 16ha. In an exemplary embodiment, the angle 58dd may be about 25.0 degrees.

The proximal end portion 58da of the handle 58d fits over the square-shaped proximal end portion 58aa of the shaft 58a so that the square-shaped proximal end portion 58aa extends into the square-shaped through-portion 58dba of the opening 58db. A washer 58e is received within the countersunk portion 58dbb of the opening 58db and a fastener such as, for example, a screw 58f extends through the opening 58db and is threadably engaged with the internal threaded connection 58af of the proximal end portion 58aa of the shaft 58a, thereby connecting the handle 58d to the shaft 58a.

A pin 58g includes a stem 58ga that extends through the bore 58ae to connect the pin to the shaft 58a. A cylindrical portion 58gb extends from the stem 58ga, and a cylindrical portion 58gc extends from the cylindrical portion 58gb. Diameters 58gd and 58ge are defined by the cylindrical portions 58gb and 58gc, respectively. In an exemplary embodiment, the diameters 58gd and 58ge may be substantially equal. In an exemplary embodiment, the diameters 58gd and 58ge may each be about 0.25 inches. Due to the different directions of extension of the cylindrical portions 58gb and 58gc, an angle 58gf is defined between the cylindrical portions 58gb and 58gc. In an exemplary embodiment, the angle 58gf may be about 150 degrees.

In an exemplary embodiment, as illustrated in FIG. 19, the cylindrical portion 58gb extends from the shaft 58a so that the cylindrical portion 58gb and the handle 58d are not aligned, that is, the cylindrical portion 58gb and the handle 58d extend from the center axis 58ag of the shaft 58a in different directions that are, for example, 180 degrees apart. In an exemplary embodiment, the cylindrical portion 58gb and the handle 58d may be aligned, extending in the same direction from the center axis 58ag. The operator 58 is adapted to engage a slider 32i. In an exemplary embodiment, the slider 32i is substantially similar to the slider 32h and therefore will not be described in detail. In the description below, any reference numerals used to refer to features of the slider 32i will correspond to the reference numerals for the features of the slider 32h, except that the first letter position for the reference numerals used to describe the slider 32h, that is, h, will be replaced by the first letter position of the reference numeral for the slider 32i, that is, i. As shown in FIG. 19, when the cover 14 is closed, the cylindrical portion 58gc of the operator 58 extends between the protrusions 32ie and 32if.

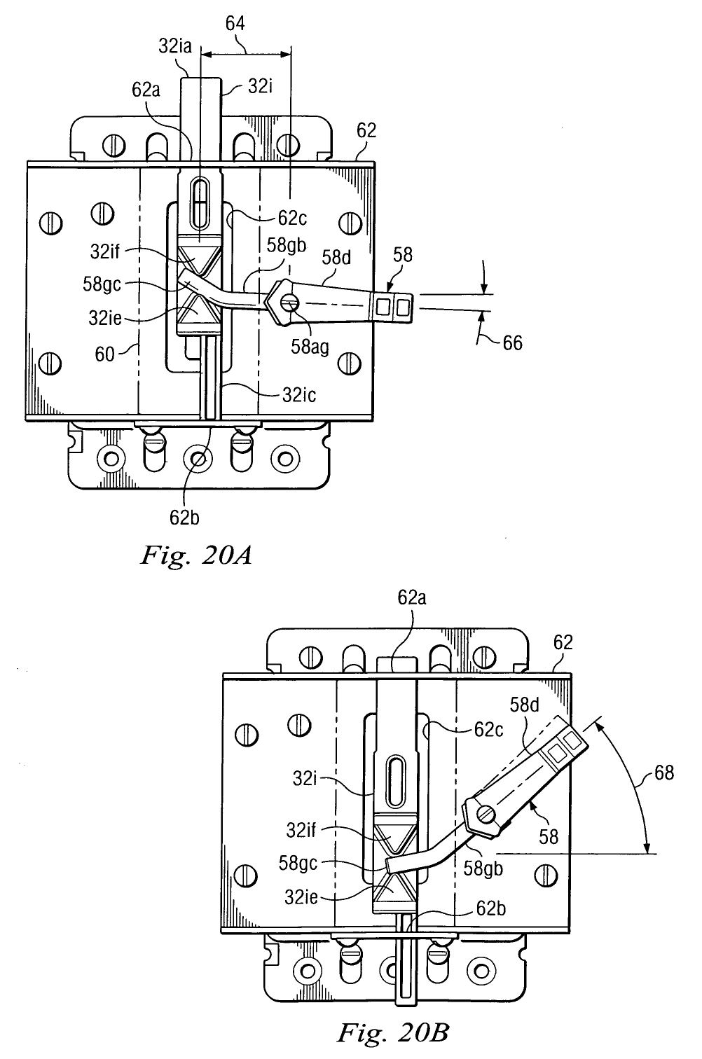

In an exemplary embodiment, as illustrated in FIG. 20A, the slider 32i is positioned over a circuit breaker 60, and the end portion 32ia of the slider 32i extends through an opening 62a in a U-shaped bracket 62, and the end portion 32ic of the slider 32i at least partially extends through an opening 62b in the U-shaped bracket. In an exemplary embodiment, the circuit breaker 60 may be in the form of a main circuit breaker. In an exemplary embodiment, the circuit breaker 60 and/or the bracket 62 may be connected to the mounting plate 24. In an exemplary embodiment, the circuit breaker may include one or more operational modes: an on operational mode, an off operational mode and a reset operational mode. In an exemplary embodiment, the circuit breaker 60 may be in the form of a Cutler Hammer ‘F’ Frame Breaker. In several exemplary embodiments, the circuit breaker 60 may be in a wide variety of forms of circuit breakers, including any forms of circuit breakers identified above.

As shown in FIG. 20A, the circuit breaker 60 is in its on operational mode. Due to the above-described extension of the cylindrical portion 58gc between the protrusions 32ie and 32if of the slider 32i, the center axis 58ag of the shaft 58a of the operator 58 is spaced from the centerline of the switch of the circuit breaker 60 (switch not shown) which, in turn, is collinear with the centerline of the slider 32i, by a predetermined spacing 64. In an exemplary embodiment, the predetermined spacing ranges from about 1.3 inches to about 1.6 inches. In an exemplary embodiment, the predetermined spacing is about 1.42 inches. In an exemplary embodiment, an opening 62c in the bracket 62 permits the slider 32i to engage the switch of the circuit breaker 60.

The handle 58d is angularly positioned so that an angle 66 is defined between the centerline of the handle and an imaginary horizontal line that is perpendicular to the direction of translation of the slider 32i. In an exemplary embodiment, the angle 66 is about 3 degrees.

To change the operational mode of the circuit breaker 60 from the on operational mode as illustrated in FIG. 20A to an off operational mode as illustrated in FIG. 20B, the slider 32i is actuated. More particularly, the handle 58d of the operator 58 is rotated counterclockwise so that the shaft 58a rotates in place about its center axis 58ag. In an exemplary embodiment, in addition to, or instead of the circuit breaker 60, the operator 58 may be used with one or more of the circuit breakers in the plurality of circuit breakers 28. In an exemplary embodiment, the bearing 58c supports the shaft 58a before, during and after the rotation of the shaft.

As a result of the rotation of the handle 58d and the shaft 58a, the pin 58g rotates counterclockwise along with the shaft 58a. During the rotation of the pin 58g, the cylindrical portion 58gc cammingly engages the protrusion 32ie, thereby actuating the slider 32i. Due to this actuation, the slider 32i is forced to slide downward, as viewed in FIGS. 20A and 20B, relative to and slidingly engaging the bracket 62. In an exemplary embodiment, during the camming engagement between the cylindrical portion 58gc and the protrusion 32ie, the cylindrical portion may contact and slidingly engage the surfaces 32iec and/or 32ied of the protrusion. Moreover, during the camming engagement between the cylindrical portion 58gc and the protrusion 32ie, the cylindrical portion may contact and slidingly engage the surfaces 32ifc and/or 32ifd of the protrusion 32if.

In an exemplary embodiment, during the counterclockwise rotation of the operator 58 including the rotation of the handle 58d, the shaft 58a and the pin 58g, and the resulting translation of the slider 32i, the contact surface 32ioa of the projection 32io of the slider 32i applies a force against the switch of the circuit breaker 60, thereby placing the switch in the off operational position and placing the circuit breaker in the off operational mode.

In an exemplary embodiment, any further translation of the slider 32i in a downward direction, as viewed in FIG. 20A, may be prevented by the engagement between the contact surface 32ioa and the switch of the circuit breaker 60. In an exemplary embodiment, any further rotation of the handle 58d and the resulting translation of the slider 32i may be prevented by the engagement of the handle 16hd with a lockout plate (not shown).

In exemplary embodiment, once the circuit breaker 60 is placed in its off operational mode as illustrated in FIG. 20B, the handle 58d is angularly positioned so that an angle 68 is defined between a centerline of the handle and an imaginary horizontal line that is perpendicular to the direction of translation of the slider 32i. In an exemplary embodiment, the angle 68 is about 41 degrees.

In an exemplary embodiment, the handle 58d may be further rotated in a counterclockwise direction to continue to apply a force to and operate the switch of the circuit breaker 60 to place the circuit breaker in its reset operational mode. In an exemplary embodiment, if the handle 58d is so rotated to place the circuit breaker 60 in its reset operational mode, then the value of the angle 68 may increase. In an exemplary embodiment, the value of the angle 68 may increase to about 45 degrees. In several exemplary embodiments, the values of the angles 66 and 68 may be equal and/or may vary widely and may be dependent upon a wide variety of factors such as, for example, the design and/or manufacturer of the circuit breaker 60.

In an exemplary embodiment, if it is desired to place the circuit breaker 60 in its on operational mode, the above-described steps are carried out in reverse, that is, the handle 58d is rotated clockwise so that the slider 32i is actuated and the operator 58 and the slider 32i are again placed in the positions shown in FIG. 20A.

In an exemplary embodiment, during and upon the closing of the cover 14, the operator 58 self locates with the slider 32i, automatically adjusting to the position of the slider, regardless of the operational mode of the circuit breaker 60, in a manner substantially similar to the manner in which each of the operators 16 self locate with the respective sliders 32, with the cylindrical portion 58gc engaging either the ramp surface 32iea or 32ifa, and rotating in response to this engagement and the approach of the operator 58 towards the slider 32i.

A system has been described that includes a slider positioned in one of at least two positions; a device adapted to approach and engage the slider; and means for automatically adjusting the device to a position corresponding to the one of the at least two positions of the slider during the device's approach and engagement with the slider so that the slider remains in the one of the at least two positions, wherein the device is permitted to actuate the slider when the device is in the position corresponding to the one of the at least two positions of the slider.

A system has been described that includes a slider positioned in one of at least two positions and comprising at least one protrusion; an enclosure in which the slider is disposed; a pin adapted to approach and engage the slider; and means for automatically adjusting the pin to a position corresponding to the one of the at least two positions of the slider during the pin's approach and engagement with the slider so that the slider remains in the one of the at least two positions, comprising an angularly-extending surface defined by the protrusion and adapted to engage the pin during the pin's approach and engagement with the slider; and means for permitting the pin to rotate in response to the pin's approach and the engagement of the pin with the angularly-extending surface, comprising a shaft connected to the pin and comprising a longitudinal axis; a bearing coupled to the shaft, wherein the shaft is adapted to rotate in a first direction about its longitudinal axis in response to the pin's approach and the engagement of the pin with the angularly-extending surface; and a cover connected to the enclosure and to which the bearing is coupled wherein the pin is adapted to approach and engage the slider in response to the closing of the cover; wherein, when the cover is closed and the pin is engaged with the slider and in the position corresponding to the one of the at least two positions of the slider, the pin is adapted to rotate and actuate the slider in response to rotation of the shaft in a second direction about its longitudinal axis; and wherein, in response to the actuation of the slider, the slider is positioned in another of the at least two positions and a circuit breaker switch is operated.

A method has been described that includes moving a device so that the device approaches and engages a slider positioned in one of at least two positions; and automatically adjusting the device to a position corresponding to the one of the at least two positions of the slider during the device's approach and engagement with the slider so that the slider remains in the one of the at least two positions; wherein the device is permitted to actuate the slider when the device is in the position corresponding to the one of the at least two positions of the slider.

A method has been described that includes engaging a slider with a switch so that the slider is positioned in one of at least two positions; moving a device so that the device approaches and engages the slider positioned in the one of the at least two positions, comprising moving a cover of an enclosure in which the slider is housed, the device being coupled to the cover and comprising a pin; automatically adjusting the device to a position corresponding to the one of the at least two positions of the slider during the device's approach and engagement with the slider so that the slider remains in the one of the at least two positions, comprising engaging the pin with an angularly-extending surface of the slider, wherein the pin rotates to a position corresponding to the one of the at least two positions of the slider in response to the device's approach and the engagement of the pin with the angularly-extending surface, and wherein the device is permitted to actuate the slider when the device is in the position corresponding to the one of the at least two positions of the slider; and actuating the slider so that the slider is positioned in another of the at least two positions after automatically adjusting the device to a position corresponding to the one of the at least two positions of the slider during the device's approach and engagement with the slider, comprising rotating the pin so that the pin cammingly engages the slider; wherein a circuit breaker switch is operated in response to actuating the slider so that the slider is positioned in the another of the at least two positions.

A system has been described that includes first and second circuit breakers positioned in a side-by-side symmetric arrangement, each of the first and second circuit breakers comprising two or more operational modes and at least one of the first and second circuit breakers comprising a button; first and second sliders engaging the first and second circuit breakers, respectively, wherein the first and second sliders are aligned with each other; and means for permitting access to the button during each of the two or more operational modes of the at least one of the first and second circuit breakers.

A system has been described that includes first and second circuit breakers positioned in a side-by-side symmetric arrangement, each of the first and second circuit breakers comprising two or more operational modes and at least one of the first and second circuit breakers comprising a button; first and second sliders engaging the first and second circuit breakers, respectively, wherein the first and second sliders are aligned with each other; and means for permitting access to the button during each of the two or more operational modes of the at least one of the first and second circuit breakers, comprising a slot in at least one of the first and second sliders, the at least one of the first and second sliders engaging the at least one of the first and second circuit breakers; means for overlapping the first and second sliders so that the first and second sliders do not interfere with one another, comprising a first end portion of the first slider, the first end portion defining a first width that is less than a first maximum width defined by the first slider; and a second end portion of the second slider, the second end portion defining a second width that is less than a second maximum width defined by the second slider; wherein the first and second end portions of the first and second sliders, respectively, overlap during each of the two or more operational modes of the at least one of the first and second circuit breakers; means for guiding the first and second end portions during relative overlapping movement between the first and second end portions; means at least partially extending in the slot for activating the button, wherein the activating means at least partially extends in the slot during each of the two or more operational modes of the at least one of the first and second circuit breakers; and means for actuating each of the first and second sliders, comprising a first device adapted to approach and engage the first slider; and a second device adapted to approach and engage the second slider; wherein the first circuit breaker is in one of the two or more operational modes of the first circuit breaker during the first device's approach; wherein the second circuit breaker is in one of the two or more operational modes of the second circuit breaker during the second device's approach; wherein the system further comprises means for automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and means for automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker; and wherein the button is able to be viewed through the slot during each of the two or more operational modes of the at least one of the first and second circuit breakers.

A method has been described that includes positioning first and second circuit breakers in a side-by-side symmetric arrangement, each of the first and second circuit breakers comprising two or more operational modes and at least one of the first and second circuit breakers comprising a button; engaging the first and second circuit breakers with first and second sliders, respectively, wherein the first and second sliders are aligned with each other after engaging the first and second circuit breakers, respectively; and permitting access to the button during each of the two or more operational modes of the at least one of the first and second circuit breakers.

A method has been described that includes positioning first and second circuit breakers in a side-by-side symmetric arrangement, each of the first and second circuit breakers comprising two or more operational modes and at least one of the first and second circuit breakers comprising a button; engaging the first and second circuit breakers with first and second sliders, respectively, wherein the first and second sliders are aligned with each other; and permitting access to the button during each of the two or more operational modes of the at least one of the first and second circuit breakers, comprising providing a slot in at least one of the first and second sliders, the at least one of the first and second sliders engaging the at least one of the first and second circuit breakers; overlapping the first and second sliders so that the first and second sliders do not interfere with one another, comprising overlapping a first end portion of the first slider with a second end portion of the second slider during each of the two or more operational modes of the at least one of the first and second circuit breakers; wherein the first end portion defines a first width that is less than a first maximum width defined by the first slider; and wherein the second end portion defines a second width that is less than a second maximum width defined by the second slider; guiding the first and second end portions during relative overlapping movement between the first and second end portions; activating the button by at least partially extending a device in the slot; and actuating each of the first and second sliders, comprising moving a first device so that the first device approaches and engages the first slider; and moving a second device so that the second device approaches and engages the second slider; wherein the first circuit breaker is in one of the two or more operational modes of the first circuit breaker during the first device's approach; wherein the second circuit breaker is in one of the two or more operational modes of the second circuit breaker during the second device's approach; wherein the method further comprises automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker; and wherein the button is able to be viewed through the slot during each of the two or more operational modes of the at least one of the first and second circuit breakers.

An apparatus has been described that includes first and second circuit breakers wherein the second circuit breaker is positioned directly beneath the first circuit breaker; first and second sliders engaged with the first and second circuit breakers, respectively; and first and second operators for actuating the first and second sliders, respectively, wherein the second operator is aligned with and positioned directly beneath the first operator so that the relative positions of the first and second operators correspond to the relative positions of the first and second circuit breakers.

An apparatus has been described that includes first and second circuit breakers wherein the second circuit breaker is positioned directly beneath the first circuit breaker; first and second sliders engaged with the first and second circuit breakers, respectively; and first and second operators for actuating the first and second sliders, respectively, wherein the second operator is aligned with and positioned directly beneath the first operator so that the relative positions of the first and second operators correspond to the relative positions of the first and second circuit breakers; wherein each of the first and second operators comprises a handle, each handle comprising an angularly-extending portion so that the handle of the second operator is in a nesting arrangement with the handle of the first operator; wherein each handle is adapted to rotate to actuate the respective first or second slider and wherein the nesting arrangement permits the second handle to rotate, relative to the first handle, over at least a predetermined range of rotation; wherein each of the first and second circuit breakers comprises a switch engaged with the respective first or second slider so that the switch is operated in response to the actuation of the respective first or second slider; wherein each of the first and second operators comprises a shaft comprising a longitudinal center axis and wherein the longitudinal center axis of the shaft of the second operator extends between the first and second circuit breakers; wherein a spacing is defined between the centerline of the switch of the second circuit breaker and the longitudinal axis of the shaft of the second operator; wherein each of the first and second circuit breakers defines a width; and wherein the spacing is substantially equal to about half of the width of the second circuit breaker to accommodate a compact arrangement between the first and second circuit breakers.

An apparatus for approaching and actuating a slider engaged with a device has been described that includes a shaft comprising a longitudinal center axis about which the shaft is adapted to rotate in place; and a pin connected to the shaft, wherein the pin is adapted to rotate and engage the slider in response to the rotation of the shaft; wherein the slider translates in response to the engagement between the pin and the slider.

An apparatus for approaching and actuating a slider engaged with a circuit breaker has been described that includes a shaft comprising an external threaded connection and a longitudinal center axis about which the shaft is adapted to rotate in place; and a pin connected to the shaft and adapted to rotate in response to the rotation of the shaft, the pin comprising a base defining a diameter of about 0.352 inches, a cam lobe extending from the base and defining a radius of about 0.750 inches, wherein the cam lobe cammingly engages the slider in response to the rotation of the shaft and the slider translates in response to the camming engagement between the cam lobe and the slider, and a planar surface adapted to be positioned proximate the slider during the camming engagement between the cam lobe and the slider; a handle connected to the shaft and aligned with the pin, the handle comprising an angularly-extending portion that is adapted to be placed in a nesting arrangement with at least one other handle, wherein the nesting arrangement between the handle and the at least one other handle permits the handle to rotate over at least a predetermined range of rotation; and a bearing through which the shaft extends, the bearing comprising an internal threaded connection threadably engaged with the external threaded connection of the shaft; wherein a switch of the circuit breaker is operated in response to the translation of the slider, the switch comprising a centerline that extends in the direction of translation of the slider, wherein a predetermined distance of about 0.5 inches is defined between the longitudinal center axis of the shaft and the centerline of the switch; and wherein the predetermined range of rotation comprises a range of rotation in a first direction to place the switch in at least one position, and a range of rotation in a second direction opposing the first direction to place the switch in at least one other position.

An apparatus for approaching and actuating a slider engaged with a circuit breaker has been described that includes a shaft comprising an external threaded connection and a longitudinal center axis about which the shaft is adapted to rotate in place; and a pin connected to the shaft and adapted to rotate in response to the rotation of the shaft, the pin comprising a generally cylindrical first portion extending from the shaft in a first direction, the first portion defining a first diameter of about 0.25 inches; and a generally cylindrical second portion extending from the first portion in a second direction, the second portion defining a second diameter that is substantially equal to the first diameter; wherein the second portion cammingly engages the slider in response to the rotation of the shaft and the slider translates in response to the camming engagement between the second portion and the slider; and wherein an angle of about 150 degrees is defined between the first and second directions; a handle connected to the shaft, the handle comprising an angularly-extending portion that is adapted to be placed in a nesting arrangement with at least one other handle, wherein the nesting arrangement between the handle and the at least one other handle permits the handle to rotate over at least a predetermined range of rotation; a bearing through which the shaft extends, the bearing comprising an internal threaded connection threadably engaged with the external threaded connection of the shaft; wherein a switch of the circuit breaker is operated in response to the translation of the slider, the switch comprising a centerline that extends in the direction of translation of the slider, wherein a predetermined distance of about 1.5 inches is defined between the longitudinal center axis of the shaft and the centerline of the switch; and wherein the predetermined range of rotation comprises a range of rotation in a first direction to place the switch in at least one position, and a range of rotation in a second direction opposing the first direction to place the switch in at least one other position.

In an exemplary embodiment, one or more of the above-described sliders 32, the operators 16 and/or the operator 58 may be used in conjunction with one-pole, two-pole and/or three-pole circuit breakers, and the sliders 32 may engage intervening parts such as, for example, tie-bars, in order apply forces to the switches of the circuit breakers to operate the switches.

In several exemplary embodiments, in addition to, or instead of panelboards, one or more of the above-described parts, components, assemblies and/or systems, including the sliders 32, the operators 16, the operator 58, the panel member 30 and/or the center strip 34 may be used in conjunction with a wide variety of enclosures. In several exemplary embodiments, a wide variety of panelboards may be used, including panelboards comprising terminal housings and other components. In addition to, or instead of circuit breaker switches, one or more of the sliders 32, the operators 16 and/or the operator 58 may be used to operate switches or other components in other devices and/or systems. In several exemplary embodiments, in addition to, or instead of the nesting of the handles of the operators 16 and/or 58, other components of the operators 16 and/or 58 may be nested in order to, for example, accommodate the compact arrangement between the circuit breakers 28. In an exemplary embodiment, the pins of the operators 16 and/or 58 may be nested if, for example, the widths of the circuit breakers 28 are less than, for example, 1 inch, or any other width. In an exemplary embodiment, the pins of the operators 16 and/or 58 may include jogs or steps so that a jog of a pin of one operator 16 or 58 may nest with a jog of a pin of another operator 16 or 58.

Any spatial references, such as, for example, “upper”, “lower”, “above”, “below”, “between”, “vertical”, “angular”, etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although exemplary embodiments have been described in detail above, those skilled in the art will readily appreciate that many other modifications are possible in the exemplary embodiments without materially departing from the novel teachings and advantages of the present disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed is:

1. A system comprising:
a slider positioned in one of at least two positions;
a device adapted to approach and engage the slider; and
means for automatically adjusting the device to a position corresponding to the one of the at least two positions of the slider during the device's approach and engagement with the slider so that the slider remains in the one of the at least two positions, wherein the device is permitted to actuate the slider when the device is in the position corresponding to the one of the at least two positions of the slider.

2. The system of claim 1 wherein, in response to the actuation of the slider, the slider is positioned in another of the at least two positions and a circuit breaker switch is operated.

3. The system of claim 1 wherein the device comprises a pin and the slider comprises at least one protrusion; and
wherein the adjusting means comprises:
an angularly-extending surface defined by the protrusion and adapted to engage the pin during the pin's approach and engagement with the slider.

4. The system of claim 3 wherein the adjusting means further comprises:
means for permitting the pin to rotate in response to the pin's approach and the engagement of the pin with the angularly-extending surface.

5. The system of claim 4 wherein the permitting means comprises:
a shaft connected to the pin and comprising a longitudinal axis; and
a bearing coupled to the shaft;
wherein the shaft is adapted to rotate in a first direction about its longitudinal axis in response to the pin's approach and the engagement of the pin with the angularly-extending surface.

6. The system of claim 5 further comprising:
an enclosure in which the slider is disposed;
wherein the permitting means further comprises:
a cover connected to the enclosure and to which the bearing is coupled;
wherein the pin is adapted to approach and engage the slider in response to the closing of the cover.

7. The system of claim 6 wherein, when the cover is closed and the pin is engaged with the slider, the pin is adapted to rotate and actuate the slider in response to rotation of the shaft in a second direction about its longitudinal axis.

8. A system comprising:
a slider positioned in one of at least two positions and comprising at least one protrusion;
an enclosure in which the slider is disposed;
a pin adapted to approach and engage the slider; and
means for automatically adjusting the pin to a position corresponding to the one of the at least two positions of the slider during the pin's approach and engagement with the slider so that the slider remains in the one of the at least two positions, comprising:
an angularly-extending surface defined by the protrusion and adapted to engage the pin during the pin's approach and engagement with the slider; and
means for permitting the pin to rotate in response to the pin's approach and the engagement of the pin with the angularly-extending surface, comprising:
a shaft connected to the pin and comprising a longitudinal axis;
a bearing coupled to the shaft, wherein the shaft is adapted to rotate in a first direction about its longitudinal axis in response to the pin's approach and the engagement of the pin with the angularly-extending surface; and
a cover connected to the enclosure and to which the bearing is coupled wherein the pin is adapted to approach and engage the slider in response to the closing of the cover;
wherein, when the cover is closed and the pin is engaged with the slider and in the position corresponding to the one of the at least two positions of the slider, the pin is adapted to rotate and actuate the slider in response to rotation of the shaft in a second direction about its longitudinal axis; and
wherein, in response to the actuation of the slider, the slider is positioned in another of the at least two positions and a circuit breaker switch is operated.

9. A method comprising:
moving a device so that the device approaches and engages a slider positioned in one of at least two positions; and
automatically adjusting the device to a position corresponding to the one of the at least two positions of the slider during the device's approach and engagement with the slider so that the slider remains in the one of the at least two positions;
wherein the device is permitted to actuate the slider when the device is in the position corresponding to the one of the at least two positions of the slider.

10. The method of claim 9 further comprising:
engaging the slider with a switch.

11. The method of claim 10 wherein the switch is adapted to be operated in response to the actuation of the slider.

12. The method of claim 11 wherein the switch is a circuit breaker switch.

13. The method of claim 9 further comprising:
actuating the slider so that the slider is positioned in another of the at least two positions after automatically adjusting the device to the position corresponding to the one of the at least two positions of the slider during the device's approach and engagement with the slider.

14. The method of claim 13 wherein a circuit breaker switch is operated in response to actuating the slider so that the slider is positioned in the another of the at least two positions.

15. The method of claim 9 wherein moving the device so that the device approaches and engages the slider positioned in the one of the at least two positions comprises:
moving a cover of an enclosure in which the slider is housed, the device being coupled to the cover.

16. The method of claim 9 wherein the device comprises a pin; and
wherein automatically adjusting the device to the position corresponding to the one of the at least two positions of the slider during the device's approach and engagement with the slider so that the slider remains in the one of the at least two positions comprises:
engaging the pin with an angularly-extending surface of the slider;
wherein the pin rotates to a position corresponding to the one of the at least two positions of the slider in response to the device's approach and the engagement of the pin with the angularly-extending surface.

17. The method of claim 16 further comprising:
actuating the slider so that the slider is positioned in another of the at least two positions after automatically adjusting the device to the position corresponding to the one of the at least two positions of the slider during the device's approach and engagement with the slider, comprising:
rotating the pin so that the pin cammingly engages the slider.

18. A method comprising:
engaging a slider with a switch so that the slider is positioned in one of at least two positions;
moving a device so that the device approaches and engages the slider positioned in the one of the at least two positions, comprising moving a cover of an enclosure in which the slider is housed, the device being coupled to the cover and comprising a pin;
automatically adjusting the device to a position corresponding to the one of the at least two positions of the slider during the device's approach and engagement with the slider so that the slider remains in the one of the at least two positions, comprising engaging the pin with an angularly-extending surface of the slider, wherein the pin rotates to a position corresponding to the one of the at least two positions of the slider in response to the device's approach and the engagement of the pin with the angularly-extending surface, and wherein the device is permitted to actuate the slider when the device is in the position corresponding to the one of the at least two positions of the slider; and
actuating the slider so that the slider is positioned in another of the at least two positions after automatically adjusting the device to a position corresponding to the one of the at least two positions of the slider during the device's approach and engagement with the slider, comprising rotating the pin so that the pin cammingly engages the slider;
wherein a circuit breaker switch is operated in response to actuating the slider so that the slider is positioned in the another of the at least two positions.

19. A system comprising:
first and second circuit breakers positioned in a side-by-side symmetric arrangement, each of the first and second circuit breakers comprising two or more operational modes and at least one of the first and second circuit breakers comprising a button;
first and second sliders engaging the first and second circuit breakers, respectively, wherein the first and second sliders are aligned with each other; and
means for permitting access to the button during each of the two or more operational modes of the at least one of the first and second circuit breakers.

20. The system of claim 19 wherein the means for permitting access comprises:
means for overlapping the first and second sliders so that the first and second sliders do not interfere with one another.

21. The system of claim 20 wherein the means for permitting access further comprises:
a slot in at least one of the first and second sliders, the at least one of the first and second sliders engaging the at least one of the first and second circuit breakers.

22. The system of claim 21 further comprising:
means at least partially extending in the slot for activating the button, wherein the activating means at least partially extends in the slot during each of the two or more operational modes of the at least one of the first and second circuit breakers.

23. The system of claim 20 wherein the means for overlapping the first and second sliders comprises:
a first end portion of the first slider, the first end portion defining a first width that is less than a first maximum width defined by the first slider; and
a second end portion of the second slider, the second end portion defining a second width that is less than a second maximum width defined by the second slider;
wherein the first and second end portions of the first and second sliders, respectively, overlap during each of the two or more operational modes of the at least one of the first and second circuit breakers.

24. The system of claim 19 further comprising:
means for actuating each of the first and second sliders.

25. The system of claim 24 further comprising:
means for guiding the first and second end portions during relative overlapping movement between the first and second end portions.

26. The system of claim 24 wherein the means for actuating each of the first and second sliders comprises:
a first device adapted to approach and engage the first slider; and
a second device adapted to approach and engage the second slider.

27. The system of claim 26 wherein the first circuit breaker is in one of the two or more operational modes of the first circuit breaker during the first device's approach; and
wherein the system further comprises:
means for automatically adjusting the first device to a position corresponding to the one of the two or more operational modes of the first circuit breaker during the first device's approach and engagement with the first slider;
wherein the first device is permitted to actuate the first slider when the first device is in the position corresponding to the one of the two or more operational modes of the first circuit breaker.

28. The system of claim 27 wherein the second circuit breaker is in one of the two or more operational modes of the second circuit breaker during the second device's approach; and
wherein the system further comprises:
means for automatically adjusting the second device to a position corresponding to the one of the two or more operational modes of the second circuit breaker during the second device's approach and engagement with the second slider;
wherein the second device is permitted to actuate the second slider when the second device is in the position corresponding to the one of the two or more operational modes of the second circuit breaker.

29. A system comprising:
first and second circuit breakers positioned in a side-by-side symmetric arrangement, each of the first and second circuit breakers comprising two or more operational modes and at least one of the first and second circuit breakers comprising a button;
first and second sliders engaging the first and second circuit breakers, respectively, wherein the first and second sliders are aligned with each other; and
means for permitting access to the button during each of the two or more operational modes of the at least one of the first and second circuit breakers, comprising:
a slot in at least one of the first and second sliders, the at least one of the first and second sliders engaging the at least one of the first and second circuit breakers;
means for overlapping the first and second sliders so that the first and second sliders do not interfere with one another, comprising:
a first end portion of the first slider, the first end portion defining a first width that is less than a first maximum width defined by the first slider; and
a second end portion of the second slider, the second end portion defining a second width that is less than a second maximum width defined by the second slider;
wherein the first and second end portions of the first and second sliders, respectively, overlap during each of the two or more operational modes of the at least one of the first and second circuit breakers;
means for guiding the first and second end portions during relative overlapping movement between the first and second end portions;
means at least partially extending in the slot for activating the button, wherein the activating means at least partially extends in the slot during each of the two or more operational modes of the at least one of the first and second circuit breakers; and
means for actuating each of the first and second sliders, comprising:
a first device adapted to approach and engage the first slider; and
a second device adapted to approach and engage the second slider;
wherein the first circuit breaker is in one of the two or more operational modes of the first circuit breaker during the first device's approach;
wherein the second circuit breaker is in one of the two or more operational modes of the second circuit breaker during the second device's approach;
wherein the system further comprises:
means for automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and
means for automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker;
and
wherein the button is able to be viewed through the slot during each of the two or more operational modes of the at least one of the first and second circuit breakers.

30. A method comprising:
positioning first and second circuit breakers in a side-by-side symmetric arrangement, each of the first and second circuit breakers comprising two or more operational modes and at least one of the first and second circuit breakers comprising a button;
engaging the first and second circuit breakers with first and second sliders, respectively, wherein the first and second sliders are aligned with each other after engaging the first and second circuit breakers, respectively; and
permitting access to the button during each of the two or more operational modes of the at least one of the first and second circuit breakers.

31. The method of claim 30 wherein permitting access to the button during each of the two or more operational modes of the at least one of the first and second circuit breakers comprises:
overlapping the first and second sliders so that the first and second sliders do not interfere with one another.

32. The method of claim 31 wherein permitting access to the button during each of the two or more operational modes of the at least one of the first and second circuit breakers further comprises:
providing a slot in at least one of the first and second sliders, the at least one of the first and second sliders engaging the at least one of the first and second circuit breakers, wherein the button is able to be viewed through the slot during each of the two or more operational modes of the at least one of the first and second circuit breakers.

33. The method of claim 32 further comprising:
activating the button by at least partially extending a device in the slot.

34. The method of claim 31 wherein overlapping the first and second sliders so that the first and second sliders do not interfere with one another comprises:
overlapping a first end portion of the first slider with a second end portion of the second slider during each of the two or more operational modes of the at least one of the first and second circuit breakers;
wherein the first end portion defines a first width that is less than a first maximum width defined by the first slider; and
wherein the second end portion defines a second width that is less than a second maximum width defined by the second slider.

35. The method of claim 30 further comprising:
actuating each of the first and second sliders.

36. The method of claim 35 further comprising:
guiding the first and second end portions during relative overlapping movement between the first and second end portions.

37. The method of claim 35 wherein actuating each of the first and second sliders comprises:
moving a first device so that the first device approaches and engages the first slider; and
moving a second device so that the second device approaches and engages the second slider.

38. The method of claim 37 wherein the first circuit breaker is in one of the two or more operational modes of the first circuit breaker during the first device's approach; and
wherein the method further comprises:
automatically adjusting the first device to a position corresponding to the one of the two or more operational modes of the first circuit breaker during the first device's approach and engagement with the first slider;
wherein the first device is permitted to actuate the first slider when the first device is in the position corresponding to the one of the two or more operational modes of the first circuit breaker.

39. The method of claim 38 wherein the second circuit breaker is in one of the two or more operational modes of the second circuit breaker during the second device's approach; and
wherein the method further comprises:
automatically adjusting the second device to a position corresponding to the one of the two or more operational modes of the second circuit breaker during the second device's approach and engagement with the second slider;
wherein the second device is permitted to actuate the second slider when the second device is in the position corresponding to the one of the two or more operational modes of the second circuit breaker.

40. A method comprising:
positioning first and second circuit breakers in a side-by-side symmetric arrangement, each of the first and second circuit breakers comprising two or more operational modes and at least one of the first and second circuit breakers comprising a button;
engaging the first and second circuit breakers with first and second sliders, respectively, wherein the first and second sliders are aligned with each other; and
permitting access to the button during each of the two or more operational modes of the at least one of the first and second circuit breakers, comprising:
providing a slot in at least one of the first and second sliders, the at least one of the first and second sliders engaging the at least one of the first and second circuit breakers;
overlapping the first and second sliders so that the first and second sliders do not interfere with one another, comprising:
overlapping a first end portion of the first slider with a second end portion of the second slider during each of the two or more operational modes of the at least one of the first and second circuit breakers;
wherein the first end portion defines a first width that is less than a first maximum width defined by the first slider; and
wherein the second end portion defines a second width that is less than a second maximum width defined by the second slider;
guiding the first and second end portions during relative overlapping movement between the first and second end portions;
activating the button by at least partially extending a device in the slot; and
actuating each of the first and second sliders, comprising:
moving a first device so that the first device approaches and engages the first slider; and
moving a second device so that the second device approaches and engages the second slider;
wherein the first circuit breaker is in one of the two or more operational modes of the first circuit breaker during the first device's approach;
wherein the second circuit breaker is in one of the two or more operational modes of the second circuit breaker during the second device's approach;
wherein the method further comprises:
automatically adjusting the first device to a position corresponding to the one of the two or more operational modes of the first circuit breaker during the first device's approach and engagement with the first slider, wherein the first device is permitted to actuate the first slider when the first device is in the position corresponding to the one of the two or more operational modes of the first circuit breaker; and
automatically adjusting the second device to a position corresponding to the one of the two or more operational modes of the second circuit breaker during the second device's approach and engagement with the second slider, wherein the second device is permitted to actuate the second slider when the second device is in the position corresponding to the one of the two or more operational modes of the second circuit breaker;
and
wherein the button is able to be viewed through the slot during each of the two or more operational modes of the at least one of the first and second circuit breakers.

41. An apparatus comprising:
first and second circuit breakers wherein the second circuit breaker is positioned directly beneath the first circuit breaker;
first and second sliders engaged with the first and second circuit breakers, respectively; and
first and second operators for actuating the first and second sliders, respectively, wherein the second operator is aligned with and positioned directly beneath the first operator so that the relative positions of the first and second operators correspond to the relative positions of the first and second circuit breakers.

42. The apparatus of claim 41 wherein each of the first and second operators comprises a handle, each handle comprising an angularly-extending portion so that the handle of the second operator is in a nesting arrangement with the handle of the first operator.

43. The apparatus of claim 42 wherein each handle is adapted to rotate to actuate the respective first or second slider; and
wherein the nesting arrangement permits the second handle to rotate, relative to the first handle, over at least a predetermined range of rotation.

44. The apparatus of claim 41 wherein each of the first and second circuit breakers comprises a switch engaged with the respective first or second slider so that the switch is operated in response to the actuation of the respective first or second slider.

45. The apparatus of claim 44 wherein each of the first and second operators comprises a shaft comprising a longitudinal center axis; and
wherein the longitudinal center axis of the shaft of the second operator extends between the first and second circuit breakers.

46. The apparatus of claim 45 wherein a spacing is defined between the centerline of the switch of the second circuit breaker and the longitudinal axis of the shaft of the second operator.

47. The apparatus of claim 46 wherein each of the first and second circuit breakers defines a width; and
wherein the spacing is substantially equal to about half of the width of the second circuit breaker to accommodate a compact arrangement between the first and second circuit breakers.

48. The apparatus of claim 41 wherein each of the first and second operators comprises:
a shaft comprising a longitudinal center axis about which the shaft is adapted to rotate in place; and
a pin connected to the shaft, wherein the pin is adapted to rotate and engage the slider in response to the rotation of the shaft;
wherein the slider translates in response to the engagement between the pin and the slider.

49. The apparatus of claim 48 wherein each of the first and second sliders comprises:
first and second end portions;
a middle portion extending between the first and second end portions; and
first and second protrusions extending from the middle portion, each of the first and second protrusions defining:
an angularly-extending surface; and
first and second side surfaces, each of the first and second side surfaces extending from the middle portion and to the angularly-extending surface.

50. The apparatus of claim 49 wherein the pins of the first and second operators are adapted to engage at least one of the first and second protrusions of the respective first and second sliders to actuate the respective first and second sliders.

51. An apparatus comprising:
first and second circuit breakers wherein the second circuit breaker is positioned directly beneath the first circuit breaker;
first and second sliders engaged with the first and second circuit breakers, respectively; and
first and second operators for actuating the first and second sliders, respectively, wherein the second operator is aligned with and positioned directly beneath the first operator so that the relative positions of the first and second operators correspond to the relative positions of the first and second circuit breakers;
wherein each of the first and second operators comprises a handle, each handle comprising an angularly-extending portion so that the handle of the second operator is in a nesting arrangement with the handle of the first operator;
wherein each handle is adapted to rotate to actuate the respective first or second slider and wherein the nesting arrangement permits the second handle to rotate, relative to the first handle, over at least a predetermined range of rotation;
wherein each of the first and second circuit breakers comprises a switch engaged with the respective first or second slider so that the switch is operated in response to the actuation of the respective first or second slider;
wherein each of the first and second operators comprises a shaft comprising a longitudinal center axis and wherein the longitudinal center axis of the shaft of the second operator extends between the first and second circuit breakers;
wherein a spacing is defined between the centerline of the switch of the second circuit breaker and the longitudinal axis of the shaft of the second operator;
wherein each of the first and second circuit breakers defines a width; and
wherein the spacing is substantially equal to about half of the width of the second circuit breaker to accommodate a compact arrangement between the first and second circuit breakers.

52. An apparatus for approaching and actuating a slider engaged with a device, the apparatus comprising:
a shaft comprising a longitudinal center axis about which the shaft is adapted to rotate in place; and
a pin connected to the shaft, wherein the pin is adapted to rotate and engage the slider in response to the rotation of the shaft;
wherein the slider translates in response to the engagement between the pin and the slider.

53. The apparatus of claim 52 wherein the device is a circuit breaker and a switch of the circuit breaker is operated in response to the translation of the slider.

54. The apparatus of claim 52 wherein the pin comprises:
a base defining a diameter; and
a cam lobe extending from the base and defining a radius, wherein the cam lobe cammingly engages the slider in response to the rotation of the shaft.

55. The apparatus of claim 54 wherein the device is a circuit breaker and a switch of the circuit breaker is operated in response to the translation of the slider; and
wherein the shaft is permitted to rotate over at least a predetermined range of rotation comprising:
a range of rotation in a first direction to place the switch in at least one position; and
a range of rotation in a second direction opposing the first direction to place the switch in at least one other position.

56. The apparatus of claim 52 wherein the pin comprises:
a generally cylindrical first portion extending from the shaft in a first direction, the first portion defining a first diameter; and
a generally cylindrical second portion extending from the first portion in a second direction, the second portion defining a second diameter;
wherein the second portion cammingly engages the slider in response to the rotation of the shaft; and
wherein an angle is defined between the first and second directions.

57. The apparatus of claim 56 wherein the device is a circuit breaker and a switch of the circuit breaker is operated in response to the translation of the slider; and
wherein the shaft is permitted to rotate over at least a predetermined range of rotation comprising:
a range of rotation in a first direction to place the switch in at least one position; and
a range of rotation in a second direction opposing the first direction to place the switch in at least one other position.

58. The apparatus of claim 52 further comprising:
a handle connected to the shaft.

59. The apparatus of claim 58 wherein the handle comprises an angularly-extending portion that is adapted to be placed in a nesting arrangement with at least one other handle; and
wherein the nesting arrangement between the handle and the at least one other handle permits the handle to rotate over at least a predetermined range of rotation.

60. An apparatus for approaching and actuating a slider engaged with a circuit breaker, the apparatus comprising:
a shaft comprising an external threaded connection and a longitudinal center axis about which the shaft is adapted to rotate in place; and
a pin connected to the shaft and adapted to rotate in response to the rotation of the shaft, the pin comprising:
a base defining a diameter of about 0.352 inches,
a cam lobe extending from the base and defining a radius of about 0.750 inches, wherein the cam lobe cammingly engages the slider in response to the rotation of the shaft and the slider translates in response to the camming engagement between the cam lobe and the slider, and
a planar surface adapted to be positioned proximate the slider during the camming engagement between the cam lobe and the slider;
a handle connected to the shaft and aligned with the pin, the handle comprising an angularly-extending portion that is adapted to be placed in a nesting arrangement with at least one other handle, wherein the nesting arrangement between the handle and the at least one other handle permits the handle to rotate over at least a predetermined range of rotation; and
a bearing through which the shaft extends, the bearing comprising an internal threaded connection threadably engaged with the external threaded connection of the shaft;
wherein a switch of the circuit breaker is operated in response to the translation of the slider, the switch comprising a centerline that extends in the direction of translation of the slider, wherein a predetermined distance of about 0.5 inches is defined between the longitudinal center axis of the shaft and the centerline of the switch; and
wherein the predetermined range of rotation comprises:
a range of rotation in a first direction to place the switch in at least one position, and
a range of rotation in a second direction opposing the first direction to place the switch in at least one other position.

61. An apparatus for approaching and actuating a slider engaged with a circuit breaker, the apparatus comprising:
a shaft comprising an external threaded connection and a longitudinal center axis about which the shaft is adapted to rotate in place; and
a pin connected to the shaft and adapted to rotate in response to the rotation of the shaft, the pin comprising:
a generally cylindrical first portion extending from the shaft in a first direction, the first portion defining a first diameter of about 0.25 inches; and
a generally cylindrical second portion extending from the first portion in a second direction, the second portion defining a second diameter that is substantially equal to the first diameter;
wherein the second portion cammingly engages the slider in response to the rotation of the shaft and the slider translates in response to the camming engagement between the second portion and the slider; and
wherein an angle of about 150 degrees is defined between the first and second directions;
a handle connected to the shaft, the handle comprising an angularly-extending portion that is adapted to be placed in a nesting arrangement with at least one other handle, wherein the nesting arrangement between the handle and the at least one other handle permits the handle to rotate over at least a predetermined range of rotation;
a bearing through which the shaft extends, the bearing comprising an internal threaded connection threadably engaged with the external threaded connection of the shaft;
wherein a switch of the circuit breaker is operated in response to the translation of the slider, the switch comprising a centerline that extends in the direction of translation of the slider, wherein a predetermined distance of about 1.5 inches is defined between the longitudinal center axis of the shaft and the centerline of the switch; and
wherein the predetermined range of rotation comprises:
a range of rotation in a first direction to place the switch in at least one position, and
a range of rotation in a second direction opposing the first direction to place the switch in at least one other position.
